(19) United States
(12) Patent Application Publication
(10) Pub. No.: US 2024/0412239 A1
(43) Pub. Date: Dec. 12, 2024

(54) SYSTEMS AND METHODS FOR TRANSFORMATION AND MANAGEMENT OF DATA WITHIN A CONFIGURABLE NETWORK

(71) Applicant: Stuzo, LLC, Philadelphia, PA (US)

(72) Inventors: Gunter Pfau, Philadelphia, PA (US); Aaron McLean, Chestertown, MD (US); Scott Wasserman, Haddonfield, NJ (US); Jakov Suran, Pula (HR); Joshua Skaroff, Philadelphia, PA (US)

(21) Appl. No.: 18/735,906

(22) Filed: Jun. 6, 2024

Related U.S. Application Data
(60) Provisional application No. 63/506,504, filed on Jun. 6, 2023.

(51) Int. Cl. G06Q 30/0202; G06Q 30/0203

(52) U.S. Cl. CPC G06Q 30/0202; G06Q 30/0203

(57) ABSTRACT

Systems and methods for transforming and managing performance data associated with a retailer network are disclosed. In one embodiment, a computing system for creating and managing a retailer network is disclosed. The computing system comprises at least one processor and a memory device. The at least one processor is programmed to perform steps including receiving an identifier for a retailer network, linking at least one retailer to the identifier, and in response to the linking the identifier to the at least one retailer, automatically receiving, from at least one remote computing device, performance data for the at least one retailer, the performance data including at least one of new member enrollment data or transaction data. The steps further include normalizing and processing the performance data and causing to be displayed, on a user interface of a user computing device, a visual representation of the processed performance data.

### CROSS-REFERENCE TO RELATED APPLICATION

This application claims the benefit of priority to U.S. Provisional Patent Application No. 63/506,504, filed Jun. 6, 2023, entitled “Retailer Connect”, the entire contents and disclosure of which is hereby incorporated by reference in its entirety.

### FIELD OF THE DISCLOSURE

The present disclosure generally relates to creating retailer networks and managing data within the retailer network, and more particularly, to computer-based systems and methods for creating a retailer network, tracking transaction data associated with the network, and processing the transaction data to enable accessibility and management of such data by various parties associated with the retailer network.

### BACKGROUND

Currently, billions of transactions are performed each month at physical merchants, online merchants, and the like. Currently there is no automated, flexible, and secure mechanism enabling parties having different hierarchical positions with a network to access this transaction data. For example, currently transaction data cannot be easily accessed by all parties in the following business relationships (i) retail corporations which offer franchise opportunities and the management stakeholders at these corporations (e.g., retail corporation franchisors), (ii) distribution companies which facilitate the sale and distribution of goods between retail corporations and business franchise owners and in some cases also own and operate retail sites, (iii) business franchise owners which operate under franchisee license agreements with retail corporation franchisors and own and operate retail sites, and/or (iv) and retail site level employees which could be employed directly by any of the aforementioned parties.

For example, an energy company (a retail corporation franchisor) has franchise relationships with hundreds, or even thousands, of independent has stations and retail convenience store sites which sell the energy company's branded fuel at their sites and does not directly control the site and/or employees at the site. Currently, there is no way for an energy company to automatically collect and analyze transaction data, in real-time, for all of its sites, a group of its sites, specific employees at its sites, and/or one or more group of employees as its sites. Further, collecting and managing data from hundreds, or thousands, of different retailer computing systems is currently a very complex and time-consuming endeavor.

Therefore, an automatic, flexible, and secure mechanism to creating a retailer network and tracking and managing transaction and other data associated with such retailer network is desirable. Conventional techniques may include other drawbacks, inefficiencies, ineffectiveness, and/or encumbrances, as well.

### BRIEF DESCRIPTION

In one aspect, a retailer connect computing system for creating and managing a retailer network is disclosed. The retailer connect computing system comprises at least one processor and a memory device. The at least one processor is programmed to receive an identifier for a retailer network and link at least one retailer to the identifier. The at least one processor is further programmed to, in response to the linking the identifier to the at least one retailer, automatically receive, from at least one remote computing device, performance data for the at least one retailer, the performance data including at least one of new member enrollment data or transaction data. The at least one processor is further programmed to normalize and process the performance data, wherein normalizing and processing the performance data identifies one or more patterns, trends, or predictions related to sales by the retailer.

In another aspect, a computer-implemented method for creating and managing a retailer network is disclosed. The computer-implemented method comprises receiving an identifier for a retailer network and linking at least one retailer to the identifier. The computer-implemented method further comprises in response to the linking the identifier to the at least one retailer, automatically receiving, from at least one remote computing device, performance data for the at least one retailer, the performance data including at least one of new member enrollment data or transaction data. The computer-implemented method further comprises normalizing and processing the performance data and causing to be displayed, on a user interface of a user computing device, a visual representation of the processed performance data.

In yet another aspect, at least one non-transitory computer-readable medium comprising instructions stored thereon for creating and managing a retailer network is disclosed. The instructions are executable by at least one processor to cause the at least one processor to perform steps including receive an identifier for a retailer network and link at least one retailer to the identifier. The instructions further cause the at least one processor to in response to the linking the identifier to the at least one retailer, automatically receive, from at least one remote computing device, performance data for the at least one retailer, the performance data including at least one of new member enrollment data or transaction data. The instructions further cause the at least one processor to normalize and process the performance data and cause to be displayed, on a user interface of a user computing device, a visual representation of the processed performance data.

Advantages will become more apparent to those skilled in the art from the following description of the preferred embodiments which have been shown and described by way of illustration. As will be realized, the present embodiments may be capable of other and different embodiments, and their details are capable of modification in various respects. Accordingly, the drawings and description are to be regarded as illustrative in nature and not as restrictive.

### BRIEF DESCRIPTION OF THE DRAWINGS

FIGS. 1-38 show example embodiments of the methods and systems described herein.

FIG. 1 is a block diagram of a computing environment for implementing a retailer connect computer system for creating and managing retailer networks in accordance with an embodiment the present disclosure.

FIG. 2 is a block diagram of a retailer connect computing device that may be used in the computer system shown in FIG. 1.

FIG. 3 is a block diagram of a server computing device that may be used in the computer system shown in FIG. 1.

FIG. 4 is a block diagram of an exemplary user computing device that may be used in the computer system shown in FIG. 1.

FIG. 5 illustrates a schematic diagram of a user interface for creating a retailer network in accordance with an embodiment the present disclosure.

FIG. 6 illustrates a schematic diagram of a user interface for viewing and managing data for a retailer network in accordance with an embodiment the present disclosure.

FIG. 7 illustrates a schematic diagram of a user interface for viewing and managing performance data of a retailer network in accordance with an embodiment the present disclosure.

FIG. 8 illustrates a schematic diagram of a user interface for viewing and managing retail site data of a retailer network in accordance with an embodiment the present disclosure.

FIG. 9 illustrates a schematic diagram of a user interface for viewing and managing employee data of a retailer network in accordance with an embodiment the present disclosure.

FIG. 10 illustrates a schematic diagram of a user interface for viewing and managing performance data of a retail site in accordance with an embodiment the present disclosure.

FIG. 11 illustrates a schematic diagram of another user interface for viewing and managing performance data of a retail site in accordance with an embodiment the present disclosure.

FIG. 12 illustrates a schematic diagram of another user interface for viewing and managing employee data in accordance with an embodiment the present disclosure.

FIG. 13 illustrates a schematic diagram of a user interface for viewing and managing site survey data in accordance with an embodiment the present disclosure.

FIG. 14 illustrates a schematic diagram of a user interface for setting performance goals in accordance with an embodiment the present disclosure.

FIG. 15 illustrates a schematic diagram of a user interface for viewing and managing offers in accordance with an embodiment the present disclosure.

FIG. 16 illustrates a schematic diagram of a user interface for creating a new offer in accordance with an embodiment the present disclosure.

FIG. 17 illustrates a schematic diagram of another user interface for creating a new offer in accordance with an embodiment the present disclosure.

FIG. 18 illustrates a schematic diagram of another user interface for creating a new offer in accordance with an embodiment the present disclosure.

FIG. 19 illustrates a schematic diagram of another user interface for creating a new offer in accordance with an embodiment the present disclosure.

FIG. 20 illustrates a schematic diagram of another user interface for viewing and managing performance data of an offer in accordance with an embodiment the present disclosure.

FIG. 21 illustrates a schematic diagram of a user interface for viewing and managing boosted offers in accordance with an embodiment the present disclosure.

FIG. 22 illustrates a schematic diagram of a user interface for creating a new boosted offer in accordance with an embodiment the present disclosure.

FIG. 23 illustrates a schematic diagram of another user interface for creating a new boosted offer in accordance with an embodiment the present disclosure.

FIG. 24 illustrates a schematic diagram of a user interface for creating or modifying retail site data in accordance with an embodiment of the present disclosure.

FIG. 25 illustrates a schematic diagram of a user interface for modifying location data for a retail site in accordance with an embodiment of the present disclosure.

FIG. 26 illustrates a schematic diagram of a user interface for viewing and managing retail sites of a retailer network in accordance with an embodiment of the present disclosure.

FIG. 27 illustrates a schematic diagram of a user interface for viewing and managing retail site data in accordance with an embodiment of the present disclosure.

FIG. 28 illustrates a schematic diagram of another user interface for viewing and managing retail site data in accordance with an embodiment of the present disclosure.

FIG. 29 illustrates a schematic diagram of a user interface for viewing and managing store employee data in accordance with an embodiment of the present disclosure.

FIG. 30 illustrates a schematic diagram of another user interface for viewing and managing store employee data in accordance with an embodiment of the present disclosure.

FIG. 30 illustrates a schematic diagram of another user interface for viewing and managing store employee data in accordance with an embodiment of the present disclosure.

FIG. 31 illustrates a schematic diagram of a user interface for viewing and creating a new employee data record in accordance with an embodiment of the present disclosure.

FIG. 33 illustrates a schematic diagram of a user interface for viewing and managing a network group of a retailer network in accordance with an embodiment of the present disclosure.

FIG. 34 illustrates a schematic diagram of another user interface for viewing and managing a network group of a retailer network in accordance with an embodiment of the present disclosure.

FIG. 35 illustrates a schematic diagram of another user interface for viewing and managing a network group of a retailer network in accordance with an embodiment of the present disclosure.

FIG. 36 illustrates a schematic diagram of a user interface for viewing and managing users of a network group in accordance with an embodiment of the present disclosure.

FIG. 37 illustrates a schematic diagram of a user interface for viewing and managing a retailer network in accordance with an embodiment of the present disclosure.

FIG. 38 is a flow diagram of a process for collecting and processing transaction data in accordance with an embodiment of the present disclosure.

### DETAILED DESCRIPTION OF THE DISCLOSURE

The following detailed description illustrates embodiments of the disclosure by way of example and not by way of limitation. The description enables one skilled in the art to make and use the disclosure, describes several embodiments, adaptations, variations, alternatives, and uses of the disclosure, including what is presently believed to be the best mode of carrying out the disclosure. The system and methods described herein are configured to address certain technical problems and challenges in collecting, maintaining, and analyzing data within complex business structures and relationships, including but not limited to: (i) retail corporations which offer franchise opportunities and the management stakeholders at these corporations (e.g., retail corporation franchisors), (ii) distribution companies which facilitate the sale and distribution of goods between retail corporations and business franchise owners and in some cases also own and operate retail sites, (iii) business franchise owners which operate under franchisee license agreements with retail corporation franchisors and own and operate retail sites, and/or (iv) and retail site level employees which could be employed directly by any of the aforementioned parties.

The technical problems addressed by the systems and methods of the disclosure include at least one of: (i) inability to receive, track, and analyze performance data of retailers, groups of retailers, and/or employees in real-time; (ii) inability to set, measure, modify, and reward performance objectives for retailers, groups of retailers, and/or employees in real-time; (iii) inability to receive, track, and analyze performance data of offers, such as discounts; and (iv) inability to link data from different retailer systems; and (v) increased complexity associated with managing data from different computing systems.

The systems and methods of the disclosure may be implemented using computer programming or engineering techniques including computer software, firmware, hardware, or any combination or subset thereof, wherein the technical effects may be achieved by steps including one or more of

The resulting technical benefits achieved by the systems and methods of the disclosure include at least one of: (i) ability to dynamically receive, track, and analyze performance data of retailers, groups of retailers, and/or employees, in real-time; (ii) ability to set, measure, modify and reward performance objectives for retailers, groups of retailers, and/or employees in real-time; (iii) ability to receive, track, and analyze performance data of offers, such as discounts, in real-time; (iv) ability create a retailer network linking retailers and their respective data; and (v) an automated and flexible computing environment for managing data from different computing systems.

In some embodiments, a computer program is provided, and the program is embodied on a computer-readable medium. In an example embodiment, the system may be executed on a single computer system, without requiring a connection to a server computer. In a further example embodiment, the system may be run in a Windows® environment (Windows is a registered trademark of Microsoft Corporation, Redmond, Washington). In yet another embodiment, the system is run on a mainframe environment and a UNIX® server environment (UNIX is a registered trademark of X/Open Company Limited located in Reading, Berkshire, United Kingdom). In a further embodiment, the system is run on an iOS® environment (iOS is a registered trademark of Apple Inc. located in Cupertino, CA). In yet a further embodiment, the system is run on a Mac OS® environment (Mac OS is a registered trademark of Apple Inc. located in Cupertino, CA). The application is flexible and designed to run in various different environments without compromising any major functionality. In some embodiments, the system includes multiple components distributed among a plurality of computing devices. One or more components are in the form of computer-executable instructions embodied in a computer-readable medium. The systems and processes are not limited to the specific embodiments described herein. In addition, components of each system and each process can be practiced independently and separately from other components and processes described herein. Each component and process can also be used in combination with other assembly packages and processes.

In some embodiments, a computer program is provided, and the program is embodied on a computer-readable medium and utilizes a Structured Query Language (SQL) with a client user interface front-end for administration and a web interface for standard user input and reports. In another embodiment, the system is web enabled and is run on a business entity intranet. In yet another embodiment, the system is fully accessed by individuals having an authorized access outside the firewall of the business-entity through the Internet. In a further embodiment, the system is being run in a Windows® environment (Windows is a registered trademark of Microsoft Corporation, Redmond, Washington). The application is flexible and designed to run in various different environments without compromising any major functionality.

As used herein, an element or step recited in the singular and preceded with the word “a” or “an” should be understood as not excluding plural elements or steps, unless such exclusion is explicitly recited. Furthermore, references to “example embodiment” or “one embodiment” of the present disclosure are not intended to be interpreted as excluding the existence of additional embodiments that also incorporate the recited features.

The term “database”, as used herein, may refer to either a body of data, a relational database management system (RDBMS), or to both. A database may include any collection of data including hierarchical databases, relational databases, flat file databases, object-relational databases, object-oriented databases, and any other structured collection of records or data that is stored in a computer system. The above examples are for example only, and thus, are not intended to limit in any way the definition and/or meaning of the term database. Examples of RDBMS's include, but are not limited to including, Oracle® Database, MySQL, IBM® DB2, Microsoft® SQL Server, Sybase®, and PostgreSQL. However, any database may be used that enables the system and methods described herein. (Oracle is a registered trademark of Oracle Corporation, Redwood Shores, California; IBM is a registered trademark of International Business Machines Corporation, Armonk, New York; Microsoft is a registered trademark of Microsoft Corporation, Redmond, Washington; and Sybase is a registered trademark of Sybase, Dublin, California.)

The term processor, as used herein, may refer to central processing units, microprocessors, microcontrollers, reduced instruction set circuits (RISC), application specific integrated circuits (ASIC), logic circuits, and any other circuit or processor capable of executing the functions described herein.

The terms “software” and “firmware”, as used herein, are interchangeable, and include any computer program stored in memory for execution by a processor, including RAM memory, ROM memory, EPROM memory, EEPROM memory, and non-volatile RAM (NVRAM) memory.

The above memory types are for example only, and are thus not limiting as to the types of memory usable for storage of a computer program.

The term “app,” as used herein, may refer generally to a software application installed and downloaded on a user computing device and executed to provide an interactive graphical user interface at the user computing device. An app associated with the computer system, as described herein, may be understood to be maintained by the computer system and/or one or more components thereof. Accordingly, a “maintaining party” of the app may be understood to be responsible for any functionality of the app and may be considered to instruct other parties/components to perform such functions via the app.

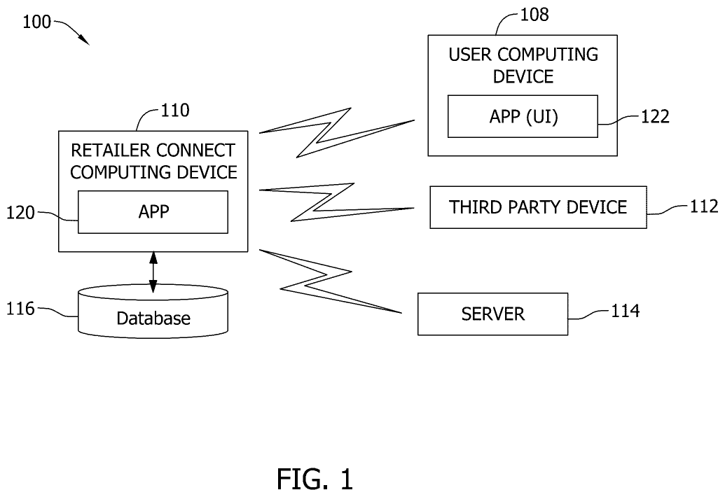

FIG. 1 depicts a block diagram of an exemplary computer system. Computer system 100 is configured to generate and manage retailer networks. Additionally, computer system 100 is configured to generate dynamic and intelligent offerings responsive to transaction data, user profile data, and/or other relevant data. In one embodiment, computer system 100 may include and/or facilitate communication between one or more user computing devices 108 (which may also be referred to as “mobile devices”), one or more retailer connect computing devices 110, one or more third-party devices 112 and/or one or more servers 114.

Retailer connect computing device 110 may be implemented as a server computing device. In one embodiment, retailer connect computing device 110 may be implemented as a server computing device with artificial intelligence (AI) and deep learning (DL) functionality. Additionally, or alternatively, retailer connect computing device 110 may be implemented as any device capable of interconnecting to the Internet, including mobile computing device or “mobile device,” such as a smartphone, a “phablet,” or other web-connectable equipment or mobile devices (such as one or more local or remote processors, servers, transceivers, sensors, memory units, mobile devices, wearables, smart watches, smart contact lenses, smart glasses, augmented reality glasses, virtual reality headsets, mixed or extended reality glasses or headsets, voice or chat bots, ChatGPT bots, and/or other electronic or electrical components, which may be in wired or wireless communication with one another).

In one embodiment, retailer connect computing device 110 may be in communication with one or more user computing devices 108, one or more third party devices 112, and/or one or more servers 114, via wireless communication or data transmission over one or more radio frequency links or wireless communication channels. In the exemplary embodiment, components of computer system 100 may be communicatively coupled to the Internet through many interfaces including, but not limited to, at least one of a network, such as the Internet, a local area network (LAN), a wide area network (WAN), or an integrated services digital network (ISDN), a dial-up-connection, a digital subscriber line (DSL), a cellular telecommunications connection (e.g., a 3G, 4G, 5G, etc., connection), a cable modem, and a BLUETOOTH connection.

Computer system 100 also includes one or more databases 116 containing information on a variety of matters. For example, database 116 may include such information as retailer and user authentication and authorization data, retailer location data, and/or any other information used, received, and/or generated by computer system 100 and/or any component thereof, including such information as described herein. In one embodiment, database 116 may include a cloud storage device, such that information stored thereon may be securely stored but still accessed by one or more components of computer system 100, such as, for example, retailer connect computing device 110, user computing devices 108, and/or servers 114. In one embodiment, database 116 may be stored on retailer connect computing device 110. Additionally, or alternatively, database 116 may be stored remotely from retailer connect computing device 110 and may be non-centralized.

In some embodiments, user computing devices 108 may be computers that include a web browser or a software application to enable user computer devices 108 to access to functionality of retailer connect computing device 110 using the Internet or a dial connection, such as a cellular network connection. User computing devices 108 may be any device capable of accessing the Internet including, but not limited to, a desktop computer, a mobile device (e.g., a laptop computer, a personal digital assistant (PDA), a cellular phone, a smartphone, a tablet, a phablet, netbook, notebook, smart watches or bracelets, smart glasses, wearable electronics, pagers, virtual reality headsets, augmented reality glasses, voice or chat bots, wearables, etc.), or other web-based connectable equipment.

User computing devices 108 may be used to access a retailer connect app 120 maintained by retailer connect computing device 110, for example, via a user interface 122 when retailer connect app 120 is executed on user computing device 108. A user may use retailer connect app 120 to provide inputs to retailer connect app 120, configure retailer networks and retailer network groups, change preferences, and perform other actions, including those described elsewhere herein.

Retailer connect computing device 110 may then generate user-specific offerings, such as incentives, and the like, to affect or influence user behavior.

Third party devices 112 may be computing devices associated with external sources of data. Retailer connect computing device 110 may request, receive, and/or otherwise access data from third party devices 112. Third party devices 112 may be any devices capable of interconnecting to the Internet, including a server computing device, a mobile computing device or “mobile device,” such as a smartphone, or other web-connectable equipment or mobile devices.

Server 114 may be associated with and/or maintained by a corporation, manufacturer, or the like, which provides corporate-run programs, offers, and the like. Server 114 may communicate with retailer connect computing device 110, user computing device(s) 108, and/or database(s) 116 in order to transmit and/or receive information associated with corporate-run programs, offers, and the like. For example, server 114 may transmit corporate-run programs, offerings, and the like, to retailer connect computing device 110, and/or may receive access to user profiles, user offerings, and the like.

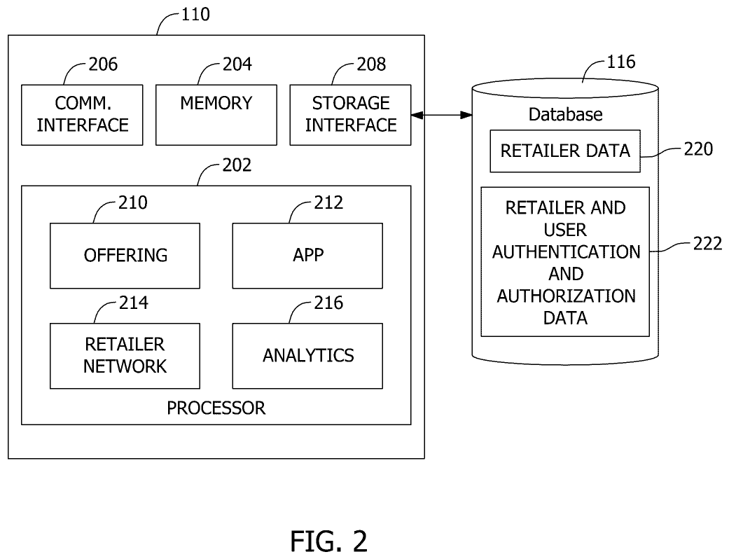

FIG. 2 depicts a retailer connect computing device 110 (as shown in FIG. 1). In one embodiment, retailer connect computing device 110 includes a processor 202, a memory 204 (which may be similar to database 116, also shown in FIG. 1), a communication interface 206, and a storage interface 208. Processor 202 is configured to execute instructions, which may be stored in memory 204. Processor 202 includes one or more processing units (e.g., in a multi-core configuration) and may be configured to execute a plurality of modules.

In some embodiments, processor 202 is operable to execute an offering module 210, a retailer network module 214, an analytics module 216, and a module 212 that maintains functionality for data management app 120 (shown in FIG. 1). Modules 210, 212, 214, and 216 may include specialized instruction sets, and/or coprocessors. Database 116 and/or memory 204 may store any data and/or instructions necessary for modules 210, 212, 214, and 216 to function as described herein. In one embodiment, database 116 may store retailer data 220 (e.g., retailer location data), retailer and user authentication and authorization data 222, and any other data described elsewhere herein.

The AI/DL module may execute artificial intelligence and/or deep learning functionality on behalf of offering module 210, retailer network module 214, and/or analytics module 216. Specifically, the AI/DL module may include any rules, algorithms, training data sets/programs, and/or any other suitable data and/or executable instructions that enable user retailer connect computing device 110 to employ artificial intelligence and/or deep learning to analyze data to generate offers and provide performance data insights, as discussed in more detail below.

Retailer network module 214 may create one or more retailer networks, as described in more detail below. The one or more retailer networks may include one or more retail sites (e.g., brick and mortar stores, websites, etc.). In one embodiment, the retail sites are organized into groups. Each retail site and/or group of retail sites may be configurable by a user, as described in more detail below. Further one or more employees may be associated with a retail site, a group of retail sites, and/or a retailer network, as also discussed in more detail below. Retailer network module 214 may track transaction data associated with a retail site, a group of retail sites, and/or a retailer network, and/or may be configured to receive this transaction data directly or indirectly from a merchant computing device (e.g., a point-of-sale device), a third-party device, a database (e.g., database 116 shown in FIGS. 1 and 2), or any other storage or computing device. In one embodiment, the transaction data is dynamically updated in real-time. Retailer network module 214 may track transaction data associated with a retail site, a group of retail sites, and/or a retailer network, and/or may be configured to receive this transaction data directly or indirectly from a merchant computing device (e.g., a point-of-sale device), a third-party device, a database (e.g., database 116 shown in FIGS. 1 and 2), or any other storage or computing device. In one embodiment, the transaction data is dynamically updated in real-time. This transaction data may then be processed, analyzed, and visualized, as discussed in more detail below.

In one embodiment, analytics module 216 may be configured to identify patterns and trends, for example, in transaction data, to determine a performance of an offering, such as a corporate-sponsored offering, as discussed in more detail below. Analytics module 216 may be further configured to make predictions. In one embodiment, analytics module 216 utilizes one or more algorithms to identify patterns and trends in transaction data and to make one or more predictions. For example, analytics module 216 may apply one or more algorithms to predict whether a retailer network, a group of retail sites, a particular retail site, and/or an employee will meet their respective performance goal. In one embodiment, analytics module 216 leverages AI/DL to identify patterns and trends and make predictions.

Offering module 210 may create offerings, such as incentives. In one embodiment, the offerings are configurable by a user, as discussed in more detail below. Offering module 210 may generate and/or transmit offerings in real-time. In some embodiment, offering module 210 may transmit the offering to one or more users in the form of an alert (e.g., within retailer connect app 120, as a text message, and/or a pop-up or push notification). Offering module 210 may be further configured to track transaction data associated with one or more offerings, as discussed in more detail below. Offering module 210 may be configured to receive this transaction data directly or indirectly from a merchant computing device (e.g., a point-of-sale device), a third-party device, a database (e.g., database 116 shown in FIGS. 1 and 2), or any other storage or computing device. In one embodiment, the transaction data is dynamically updated in real-time. This transaction data may then be processed, analyzed, and visualized, as discussed in more detail below.

App module 212 is configured to facilitate maintaining retailer connect app 120 and providing the functionality thereof to users. App module 212 may store instructions that enable download and/or execution of retailer connect app 120 at user computing devices 108, third-party devices, 112, and/or any other computing device. App module 216 may store instructions regarding user interfaces, offerings, conditions, and the like, into a format suitable for transmitting to a computing device for display thereof.

In one embodiment, processor 202 is operatively coupled to communication interface 206 such that retailer connect computing device 110 is capable of communicating with remote devices, such as user computer devices 108, third party devices 112, servers 114, and the like (all shown in FIG. 1) over a wired or wireless connection. For example, retailer connect computing device 110 may receive transaction data from one or more merchant computing devices (e.g., a merchant point-of sale device) and PII from a user computing device 108. Communication interface 206 may include, for example, a wired or wireless network adapter and/or a wireless data transceiver for use with a mobile telecommunications network.

Processor 202 may also be operatively coupled to database 116 and/or any other storage device via storage interface 208. Database 116 may be any computer-operated hardware suitable for storing and/or retrieving data. In some embodiments, database 116 may be integrated in retailer connect computing device 110.

Offering module 210 may transmit the offering to one or more users within the retailer connect app 120. Additionally, or alternatively, offering module 210 may transmit the user offering to one or more users as a pop-up or push-notification, through a text message, e-mail, and/or the like. For example, retailer connect computing device 110 may include one or more hard disk drives as database 116. In other embodiments, database 116 is external to retailer connect computing device 110 and is accessed by a plurality of computer devices. For example, database 116 may include a storage area network (SAN), a network attached storage (NAS) system, multiple storage units such as hard disks and/or solid-state disks in a redundant array of inexpensive disks (RAID) configuration, cloud storage devices, and/or any other suitable storage device.

Storage interface 208 may be any component capable of providing processor 202 with access to database 116. Storage interface 208 may include, for example, an Advanced Technology Attachment (ATA) adapter, a Serial ATA (SATA) adapter, a Small Computer System Interface (SCSI) adapter, a RAID controller, a SAN adapter, a network adapter, and/or any component providing processor 202 with access to database 116.

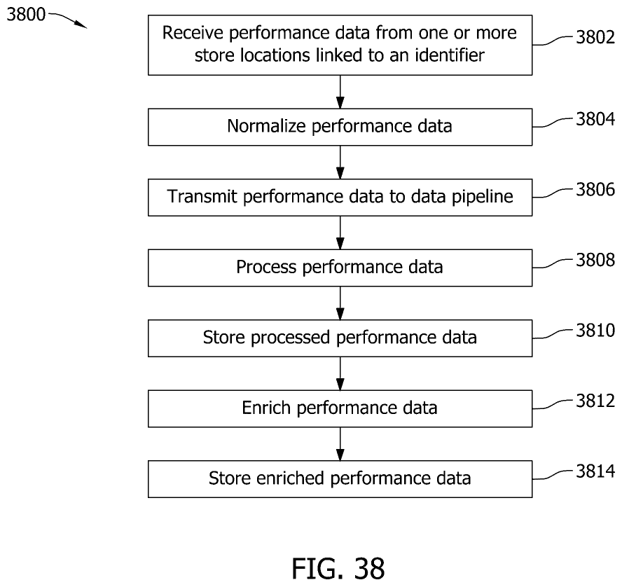

Processor 202 may execute computer-executable instructions for implementing aspects of the disclosure. In some embodiments, processor 202 may be transformed into a special purpose microprocessor by executing computer-executable instructions or by otherwise being programmed. For example, processor 202 may be programmed with the instructions such as those illustrated in FIG. 38.

Memory 204 may include, but is not limited to, random access memory (RAM) such as dynamic RAM (DRAM) or static RAM (SRAM), read-only memory (ROM), erasable programmable read-only memory (EPROM), electrically erasable programmable read-only memory (EEPROM), and non-volatile RAM (NVRAM). The above memory types are example only, and are thus not limiting as to the types of memory usable for storage of a computer program.

In one embodiment, retailer connect computing device 110 may also maintain retailer connect software application or “app” 120 which enables users to create retailer networks, to track various metrics associated with performance, such as transaction data, adjust offerings, and access a plurality of services associated with computer system 100, including receiving, responding, and tracking the redeeming of offerings, as discussed in more detail below. Retailer connect app 120 may be executed on user computing devices 108, as described elsewhere herein.

In one embodiment, retailer connect computing device 110 enables a user to view transaction data, employee performance data, and/or additional or alternative data collected by user computing devices 108, third party devices 112, and/or other data transmitted to retailer computing device 110. Retailer connect app 120 may further enable a user to create and modify a retailer network, track performance of a retailer network, one or more retailers, or one or more users, to view formatted data, and the like. Retailer connect app 120 may also enable a user to sync retailer networks, profiles, and the like, with other services or apps on their device(s), such as a corporate loyalty app.

In one embodiment, retailer connect computing device 110 further includes AI/DL module 210 (not shown). AI/DL module may execute artificial intelligence and/or deep learning functionality. Specifically, AI/DL module may include any rules, algorithms, training data sets/programs, and/or any other suitable data and/or executable instructions that enable retailer connect computing device 110 to employ artificial intelligence and/or deep learning to generate user profiles, consumer offerings, employee offerings, and the like.

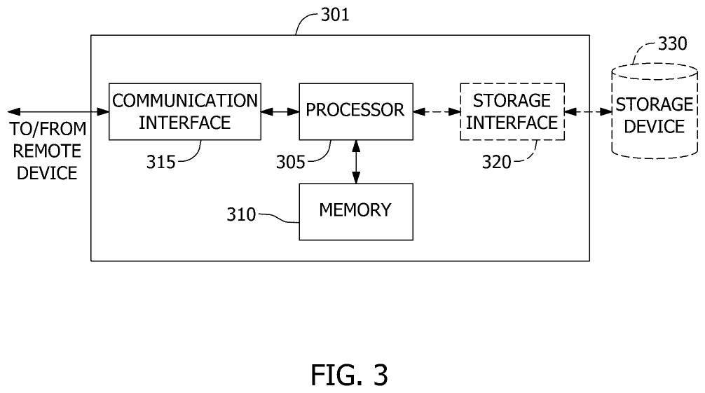

FIG. 3 is a schematic diagram of an example configuration of a server computing device 301, in accordance with some embodiments of the present disclosure. Server computing devices having an architecture similar to server computing device 300 may be used to implement one or more of the computing systems shown in FIG. 1. In the example embodiment, server computing device 300 includes processor 305 for executing instructions (not shown) stored in a memory 310. In an embodiment, processor 305 may include one or more processing units (e.g., in a multi-core configuration). The instructions may be executed within various different operating systems, such as UNIX®, LINUX® (LINUX is a registered trademark of Linus Torvalds), Microsoft Windows®, etc. It should also be appreciated that upon initiation of a computer-based method, various instructions may be executed during initialization. Some operations may be required in order to perform one or more processes described herein, while other operations may be more general or specific to a particular programming language (e.g., C, C#, C++, Java, or other suitable programming languages, etc.).

In the example embodiment, processor 305 is operatively coupled to a communication interface 315 such that server computing device 300 is capable of communicating with a remote device, such as a user or system administrator computing system (not shown) or another server computing device 300.

In the example embodiment, processor 305 is also operatively coupled to a storage device 330, which may be, for example, a computer-operated hardware unit suitable for storing or retrieving data. In some embodiments, storage device 330 is integrated into server computing device 300. For example, device 300 may include one or more hard disk drives as storage device 330. In other embodiments, storage device 330 is external to device 300 and may be accessed by a plurality of server computing devices 300. For example, storage device 330 may include multiple storage units such as hard disks or solid-state disks in a redundant array of inexpensive disks (RAID) configuration. Storage device 330 may include a storage area network (SAN) or a network attached storage (NAS) system. Storage device 330 may be used as a repository for one or more databases or other data structures for storing various data elements received, processed, and/or generated by retailer connect computing device 110 and/or any other computing device discussed herein.

In some embodiments, processor 305 is operatively coupled to storage device 330 via an optional storage interface 320. Storage interface 320 may include, for example, a component capable of providing processor 305 with access to storage device 330. In an exemplary embodiment, storage interface 320 further includes one or more of an Advanced Technology Attachment (ATA) adapter, a Serial ATA (SATA) adapter, a Small Computer System Interface (SCSI) adapter, a RAID controller, a SAN adapter, a network adapter, or a similarly capable component providing processor 305 with access to storage device 330.

Memory area 310 may include, but is not limited to, random-access memory (RAM) such as dynamic RAM (DRAM) or static RAM (SRAM), read-only memory (ROM), erasable programmable read-only memory (EPROM), electrically erasable programmable read-only memory (EEPROM), non-volatile RAM (NVRAM), and magneto-resistive random-access memory (MRAM). The above memory types are for example only, and are thus not limiting as to the types of memory usable for storage of a computer program.

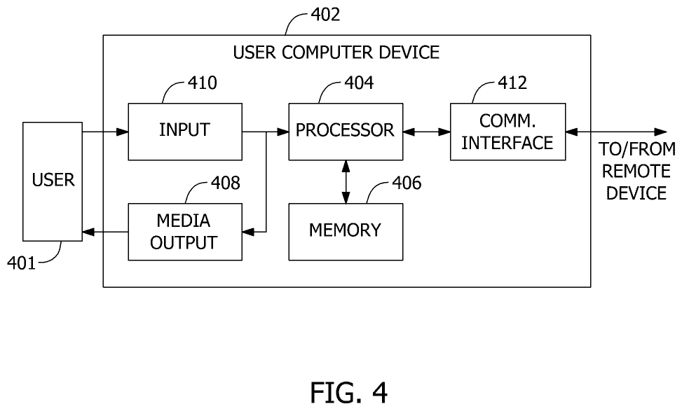

FIG. 4 illustrates an example configuration of a user computing device 402. User computing device 402 includes a processor 404 for executing instructions. In some embodiments, executable instructions are stored in a memory area 406. Processor 404 may include one or more processing units (e.g., in a multi-core configuration). Memory area 406 is any device allowing information such as executable instructions and/or other data to be stored and retrieved. Memory area 406 may include one or more computer-readable media.

User computing device 402 also includes at least one media output component 408 for presenting information to a user. Media output component 408 is any component capable of conveying information to user. In some embodiments, media output component 408 includes an output adapter such as a video adapter and/or an audio adapter. An output adapter is operatively coupled to processor 404 and operatively couplable to an output device such as a display device (e.g., a liquid crystal display (LCD), organic light emitting diode (OLED) display, cathode ray tube (CRT), or “electronic ink” display) or an audio output device (e.g., a speaker or headphones). For example, an account holder may view their payment account and posted amounts on their payment account via media output component 408.

In some embodiments, user computing device 402 includes an input device 410 for receiving input from user. Input device 410 may include, for example, a keyboard, a pointing device, a mouse, a stylus, a touch sensitive panel (e.g., a touch pad or a touch screen), a camera, a gyroscope, an accelerometer, a position detector, and/or an audio input device. A single component such as a touch screen may function as both an output device of media output component 408 and input device 410.

User computing device 402 may also include a communication interface 412, which is communicatively couplable to a remote device such as a server system or a web server operated by a merchant. Communication interface 412 may include, for example, a wired or wireless network adapter or a wireless data transceiver for use with a mobile phone network (e.g., Global System for Mobile communications (GSM), 3G, 4G or Bluetooth) or other mobile data network (e.g., Worldwide Interoperability for Microwave Access (WIMAX)).

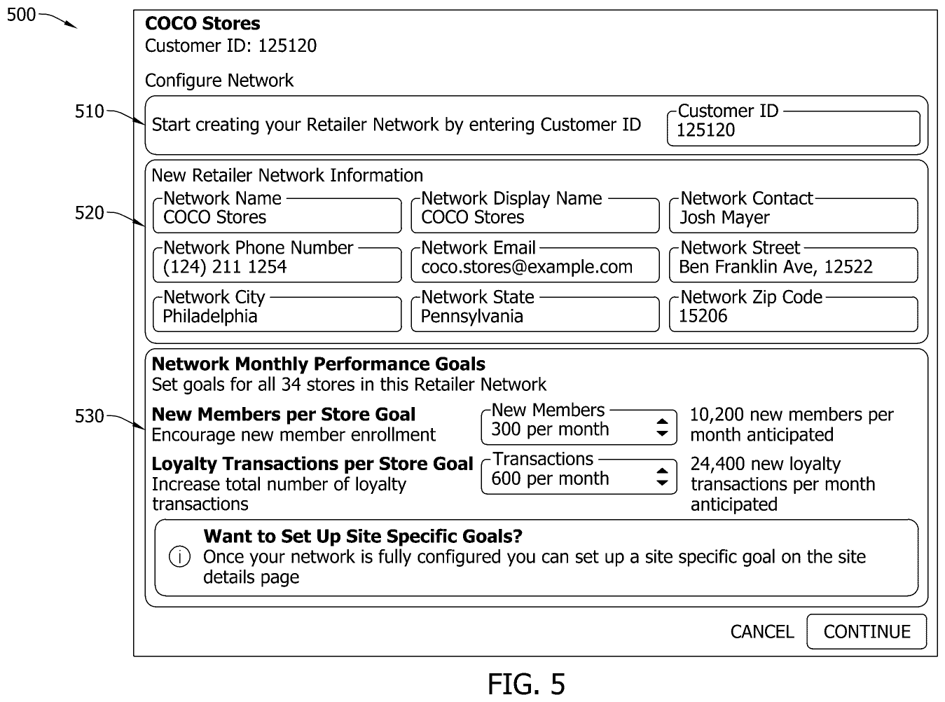

FIGS. 5-37 depict exemplary screen captures or “screenshots” of user interface of retailer connect app 120 as executed on a retailer connect computing device 110, a user computing device 108, and/or a third-party device 112 (all shown in FIG. 1), and/or any other computing device. The example screenshots include various features and functionalities of retailer connect app 120.

FIG. 5 depicts a first user interface 500 of retailer connect app 120. First screenshot 500 may include an identifier section 510, a new retailer network information section 520, and/or a network monthly performance goals section 510. Sections 510, 520, 530 may include a plurality of fillable or selectable data elements. In one embodiment, identifier section 510 includes a fillable or selectable data element for entering an identifier, such as a customer identification number. In one embodiment, an identifier is needed to create a retailer network. The identifier (e.g., a customer identification number) may be provided after the retailer connect product is purchased or otherwise made available to the retailer. The retailer network may be associated with a corporation, a franchise, a manufacturer, and the like. In the embodiment illustrated in FIG. 5, the retailer network is created for “COCO Stores” which has 34 retail sites. The retailer network may include a plurality of subgroups, such as a plurality of stores, as described in more detail below.

New retailer network information section 520 may include a plurality of fillable or selectable data elements for entering information about the retailer, such as a network name, a network display name, a network contact, a network phone number, a network email, a network address (street, city, state, zip code, etc.).

Network monthly performance goals section 510 may include one or more fillable forms or other mechanism (e.g., a drop-down list) for setting one or more performance goals for the retailer network. For example, in the embodiment illustrated in FIG. 5, user interface 500 includes a first drop-down list for a new members per store monthly goal (to encourage new member enrollment) and a second drop down list for a loyalty transactions per store monthly goal (to increase a total number of loyalty transactions). First user interface 500 may include mechanisms to specify additional or alternative performance goals. As such, first user interface 500 enables a user to create a retailer network for a retailer and to set performance goals for such retailer network.

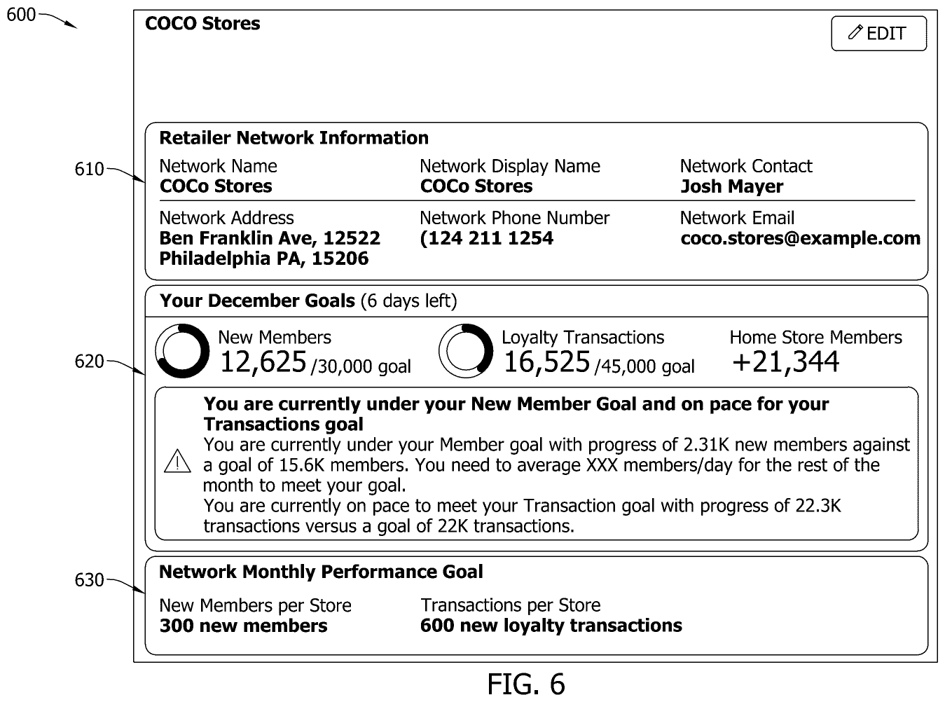

FIG. 6 depicts another user interface 600 of retailer connect app 120. User interface 600 may display a retailer network information section 610 displaying the retailer network information, a goal snapshot section 620, and/or a network performance goal section 630 displaying the selected network performance goals (e.g., new members per store monthly goal and transactions per store monthly goal). Goal snapshot section 620 may display a snapshot of the progress of the one or more performance goals and may be dynamically updated in real-time. For example, in the embodiment illustrated in FIG. 6, snapshot section 620 includes a graph illustrating the number of new member enrollment in the current month compared to the new member enrollment goal for the month and the number of loyalty transactions in the current month compared to the loyalty transaction goal for the month. Additionally, or alternatively, snapshot section 620 may include additional information, such as the time left to achieve the one or more performance goals. For example, in the embodiment illustrated in FIG. 6, goal snapshot section 620 indicates there are 6 days left in the current month of December to achieve the performance goals. Additionally, or alternatively, snapshot section 620 may include additional insights, such as whether the retailer is has met or has not met one or more performance goals, whether the retailer is on pace to meet one or more of their performance goals, the pace the retailer needs to achieve to meet their performance goal, and any other insights into retailer performance with respect to previously defined goals.

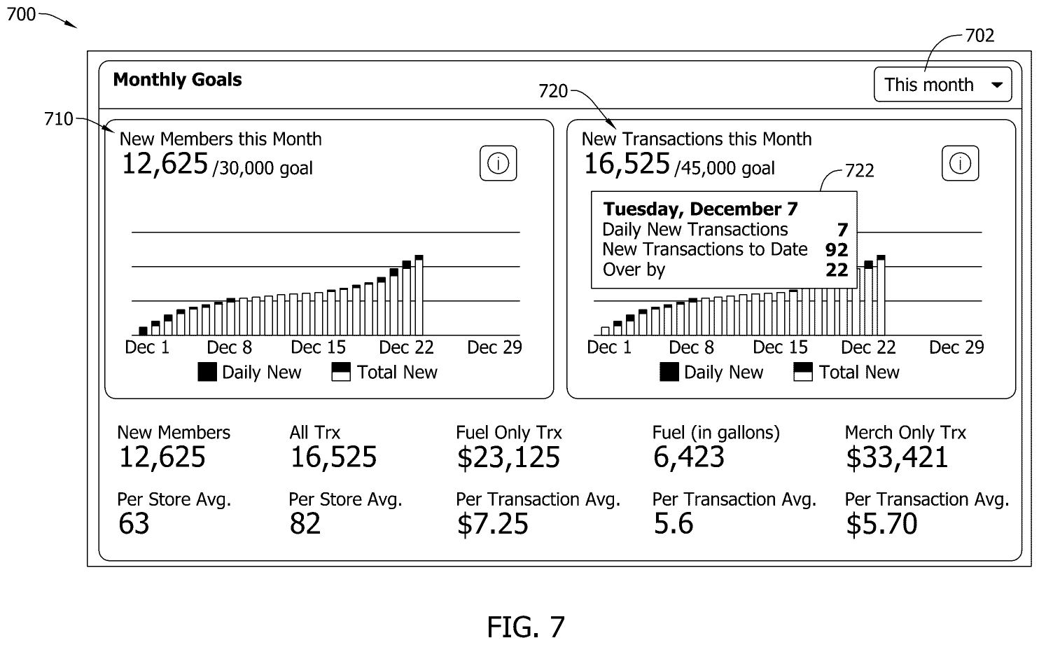

FIG. 7 depicts another user interface 700 of retailer connect app 120. User interface 700 may display detailed retailer performance data with respect to previously defined goals. User interface 700 may include a drop-down list 702 or other mechanism by which a user can select a time period (e.g., this month's goals). In the embodiment illustrated in FIG. 7, user interface 700 displays a first graph 710 showing new member enrollment as a function of time and a second graph 720 showing new transactions as a function of time. In one embodiment, when a user moves a cursor over first graph 710 and/or second graph 720, additional details may be displayed. For example, in the embodiment illustrated in FIG. 7, a user may see additional detail data 722 for a specific date, the number of new transactions on that date, the new transactions up to that date, and the remaining time period the retailer has to achieve the goal. Additionally, or alternatively, user interface 700 may include additional performance goal insight information. For example, in the embodiment illustrated in FIG. 7, user interface 700 displays the numerical value of new member enrollment, the per store average of new member enrollment, the numerical value of all new transactions, the per store average of all new transactions, the monetary value of transactions associated with a particular good or service (e.g., fuel), the average monetary value per transaction associated with the particular food or service (e.g., fuel), the number of units of the good or service purchase (e.g., gallons of fuel), the average units of the good or service per transaction (e.g., gallons of fuel per transaction), the monetary value of transactions completed at merchants, and/or the average monetary value per transaction.

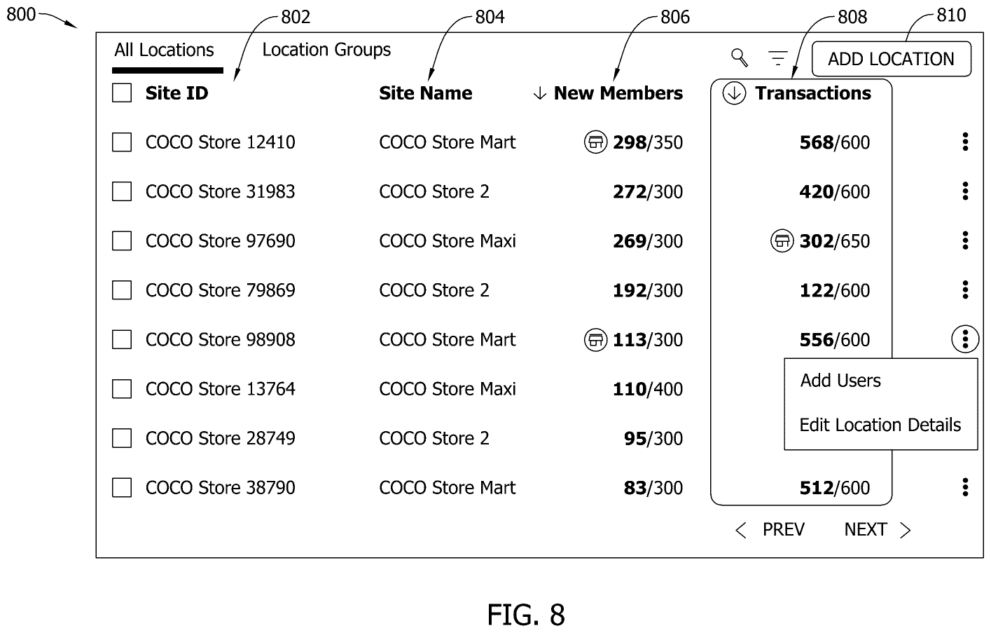

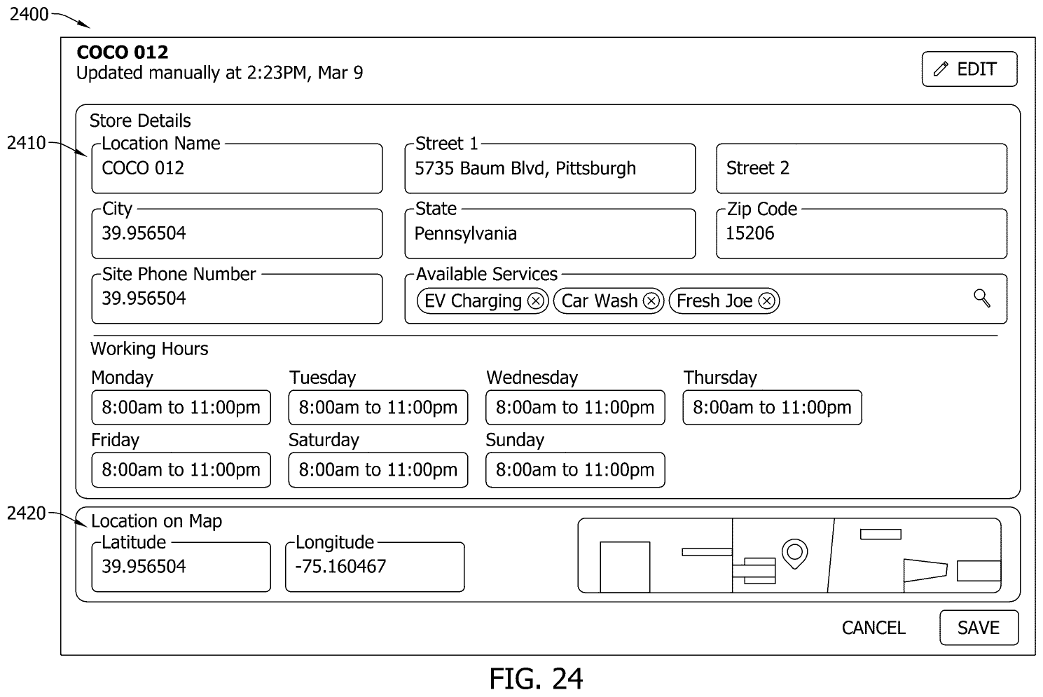

FIG. 8 depicts another user interface 800 of retailer connect app 120. User interface 800 may list all locations included in the retailer network. In one embodiment, user interface 800 may display, for each location of the retailer network, one or more of a site identifier 802, a site name 804, performance goal data (e.g., new member enrollment information 806, new transaction information 808), and/or any other information associated with a site location. In one embodiment, each site location has its own specific performance goal. In a further embodiment, the performance goals for each site location is configurable by the user. In the embodiment illustrated in FIG. 8, user interface 800 displays the number of new member enrollments for each site location and the new member enrollment goal for the respective site location. Further, in the embodiment illustrated in FIG. 8, user interface 800 displays the number of new transactions for each site location and the new transaction goal for the respective site location. In one embodiment, the performance goal information for each site location may include an indicator, such as colored text, an icon, and the like. For example, in one embodiment, if a site location has not met its performance goal for new member enrollment, the site location's new member enrollment information may be in a red text and if a site location has met its performance goal for new member enrollment, the site location's new member enrollment information may be in green text. In one embodiment, user interface 800 provides a button 810 or other mechanism which re-directed a user to another user interface which enables a user to link a retail site to the retailer network, as discussed in more detail with regards to FIG. 24.

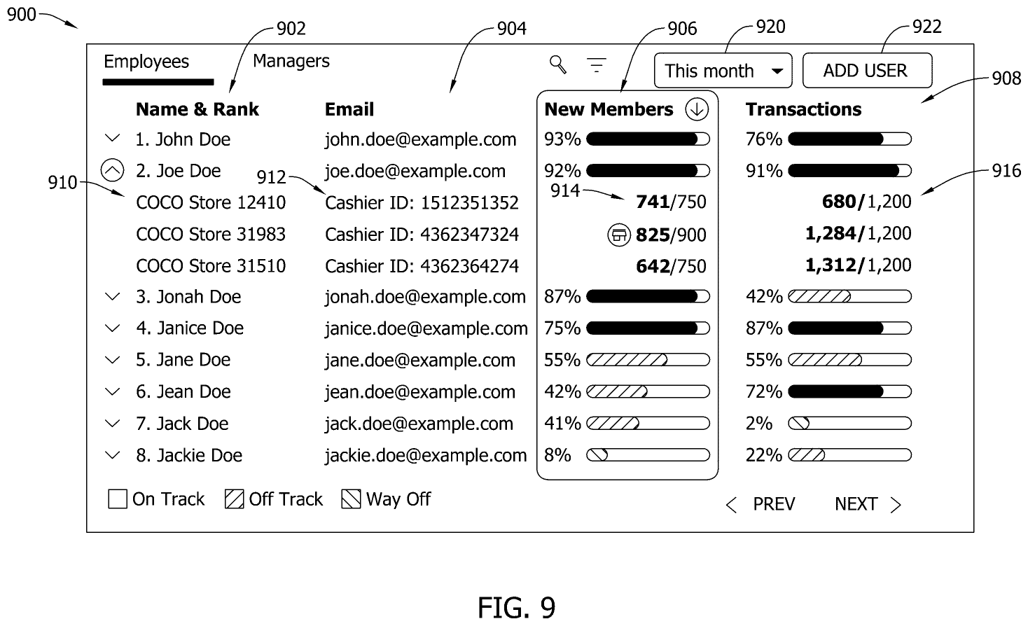

FIG. 9 depicts another user interface 900 of retailer connect app 120. User interface 900 may list all locations included in the retailer network. User interface 900 may list employees 902 associated with a retailer network and/or a subgroup within a retailer network, and personal information, such as an email address 904 for each employee 902. In one embodiment, the employee list is in order of the employee rank based on employee performance. User interface 900 may display a snapshot of the employee's performance, which may be dynamically updated in real-time. For example, new member enrollments credited to the employee and new transactions credited to the employee are displayed for each employee. New member enrollments, transactions, etc. can be credited to the employee by the employee entering an identifier at the point-of-sale device or other retailer computing device during their shift. User interface 900 may include a drop-down list 902 or other mechanism by which a user can select a time frame (e.g., this month). In one embodiment, each employee has their own specific performance goal. In a further embodiment, the performance goals for each employee is configurable by the user. In one embodiment, each employee has the same performance goals. In the embodiment illustrated in FIG. 9, a percent of the new member enrollment goal 906 and a percent of the new transaction goal 908 is shown for each employee. In one embodiment, user interface 900 may display additional data, such as retail sites a specific employee is associated with 910, an identifier for the specific employee at the respective retail site 912, and/or a snapshot of the employee's performance at the respective retail site 914, 916.

For example, in the embodiment illustrated in FIG. 9, by clicking on an arrow next to an employee's name, one or more retail sites the employee is associated with 910 are displayed, the cashier ID for the employee at each specific retail site are displayed, new member enrollments credited to the employee as compared to the new member enrollment goal for the employee is displayed, and new transactions credited to the employee as compared to the new transaction goal for the employee is displayed. In one embodiment, the performance goal information for each employee may include an indicator, such as a color, an icon, and the like. For example, in one embodiment, if an employee is below a first performance goal threshold for new member enrollment indicating the employee is way off of their performance goal, the employee's new member enrollment information may be displayed in a red, if an employee is below a second performance goal threshold for new member enrollment indicating the employee is off track of their performance goal, the employee's new member enrollment information may be displayed in orange, and if an employee has met or exceeded goal threshold for new member enrollment, the employee's new member enrollment information may be displayed in green. Button 922 or other mechanism may cause a pop-up to be displayed or re-direct to another user interface which enables a user to create a new data record for a new employee and link the new employee to the retailer network and/or one or more retail sites.

In one embodiment, when a new data record is created for an employee, the information contained in the new data record is used to automatically create a loyalty program profile for the employee. In this way, the employee may be provided rewards, offers, discounts, and the like. In one embodiment, the employee's performance data is linked to their loyalty program profile. In a further embodiment, the employee's performance data can be used to generate rewards, offers, and discounts, or the like. In one embodiment, the employee's performance data may automatically trigger an offer, discount, and the like to be uploaded to the employee's loyalty program profile. For example, in one embodiment, the employee's performance data may be continually compared to one or more of the employee's performance goal. The comparison indicates the performance has met one or more of their goals, a discount or other offer (e.g., a free coffee) may be transmitted to the employee's loyalty profile, where a user may activate or redeem such offer.

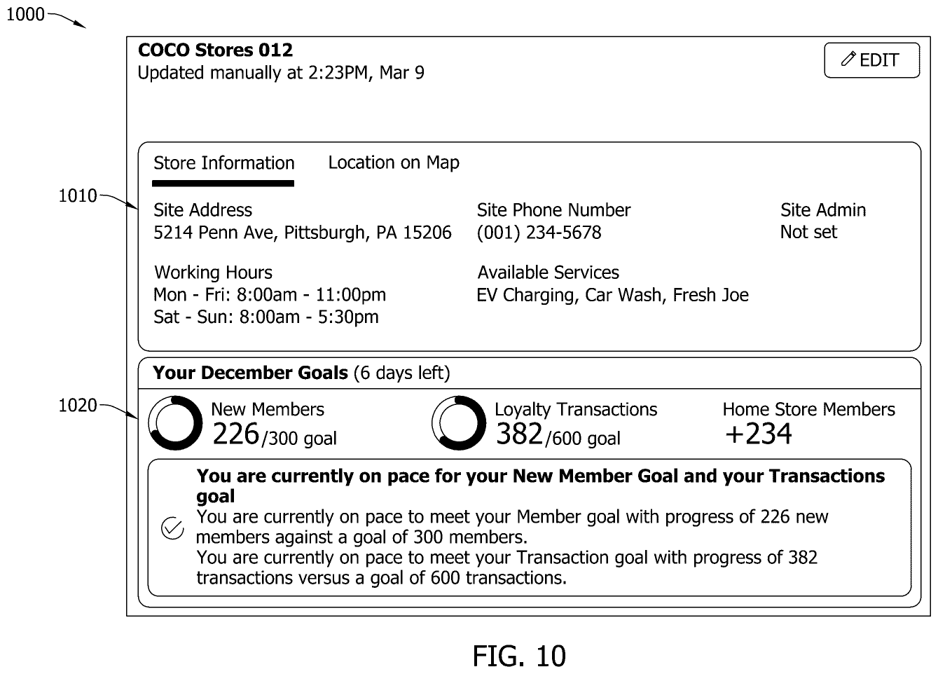

FIG. 10 depicts another user interface 1000 of retailer connect app 120. User interface 1000 may display a store information section 1010 for a particular retail site and/or a goal snapshot section 1020. Goal snapshot section 1020 may display a snapshot of the progress of the one or more performance goals and may be dynamically updated in real-time. For example, in the embodiment illustrated in FIG. 10, snapshot section 1020 includes a graph illustrating the number of new member enrollments in the current month for the retail site compared to the new member enrollment goal for the month for the retail site and the number of loyalty transactions in the current month for the retail site compared to the loyalty transaction goal for the month for the retail site. Additionally, or alternatively, snapshot section 1020 may include additional information, such as the time left to achieve the one or more performance goals. For example, in the embodiment illustrated in FIG. 10, goal snapshot section 1020 indicates there are 6 days left in the current month of December to achieve the performance goals. Additionally, or alternatively, snapshot section 1020 may include additional insights, such as whether the retailer is has met or has not met one or more performance goals, whether the retail site is on pace to meet one or more of their performance goals, the pace the retail site needs to achieve to meet their performance goal, and any other insights into retail site performance with respect to previously defined goals.

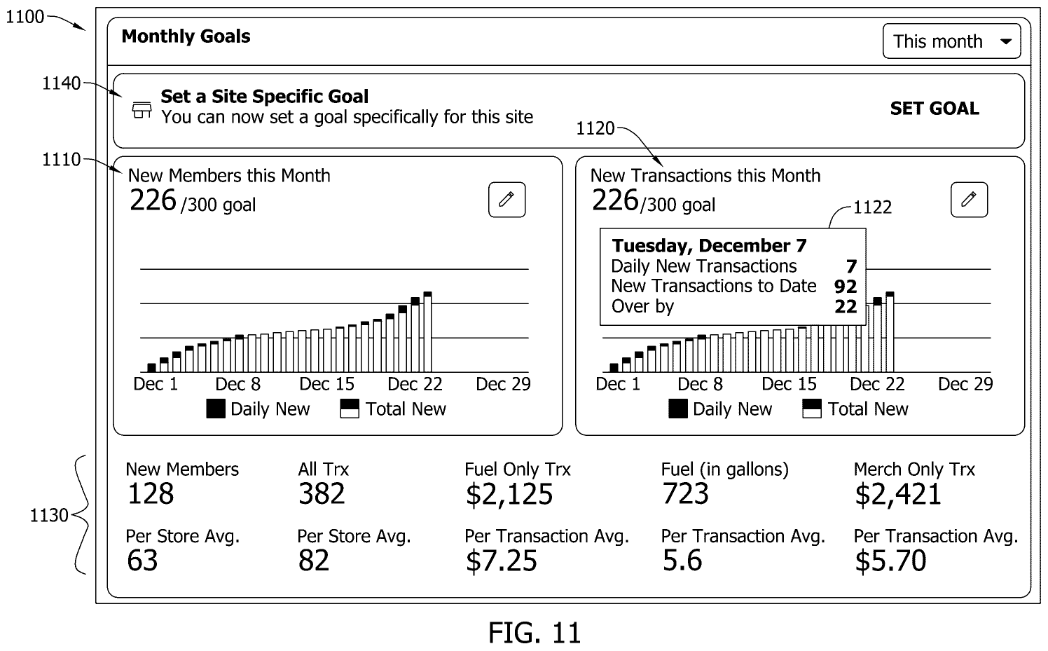

FIG. 11 depicts another user interface 1100 of retailer connect app 120. User interface 1100 may display detailed retail site performance data with respect to previously defined goals. In the embodiment illustrated in FIG. 11, user interface 1100 displays a first graph 1110 showing new member enrollment for a retail site as a function of time and a second graph 1120 showing new transactions for a retail site as a function of time. In one embodiment, when a user moves a cursor over first graph 1100 and/or second graph 1120, additional details may be displayed. For example, in the embodiment illustrated in FIG. 11, a user may see additional detail data 1122 for a specific date, the number of new transactions on that date, the new transactions up to that date, and the remaining time period the retail site has to achieve the goal. Additionally, or alternatively, user interface 1100 may include additional performance goal insight information 1130. For example, in the embodiment illustrated in FIG. 11, user interface 1100 displays the numerical value of new member enrollment for the retail site, the per day average of new member enrollment for the retail sit, the numerical value of all new transactions for the retail site, the per day average of all new transactions for the retail site, the monetary value of transactions associated with a particular good or service (e.g., fuel), the average monetary value per transaction associated with the particular food or service (e.g., fuel), the number of units of the good or service purchase (e.g., gallons of fuel) and/or the average units of the good or service per transaction (e.g., gallons of fuel per transaction). In one embodiment, user interface 1100 further comprises a goal set section 1140 which includes a link, button, or other mechanism which causes a pop-up to be displayed and/or re-directs the user to another user interface which enables a user can configure specific goals for the retail site, as discussed in more detail with regards to FIG. 14.

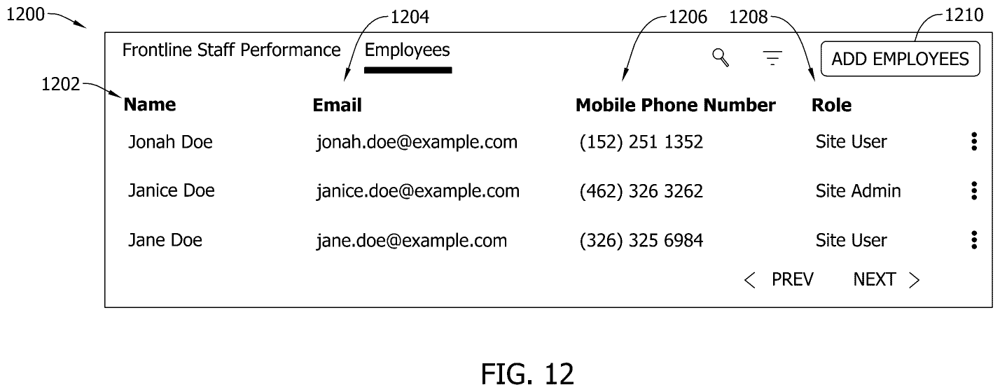

FIG. 12 depicts another user interface 1200 of retailer connect app 120. User interface 1200 may include a list of employees at a specific retail site, including a name 1202, email address 1204, mobile phone number 1206, role 1208 and/or any other relevant information. In one embodiment, user interface 1200 includes a button 1210 or other mechanism to link a new employee to the retail site.

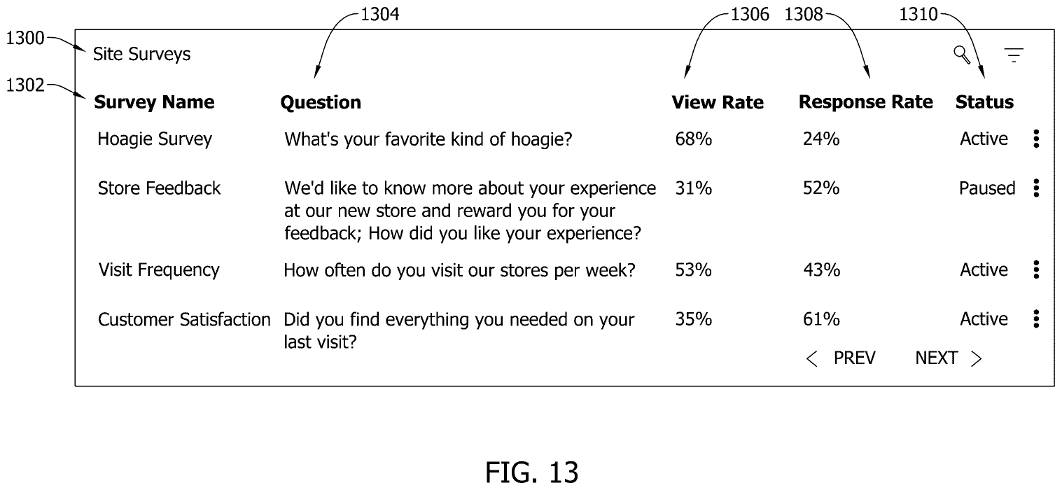

FIG. 13 depicts another user interface 1300 of retailer connect app 120. User interface 1300 may include a list of surveys associated with the retail site. In one embodiment, the surveys are completed by current customers, potential customers, and/or previous customers of the retail site. The surveys may comprise a wallet steering survey, as disclosed in U.S. application Ser. No. 18/174,434, filed Feb. 24, 2023, entitled “WALLET STEERING: SYSTEM, ENGINE, METHOD, AND PROFESSIONAL SERVICES TO PROGRAMMATICALLY, PRECISELY, AND PROFITABLY STEER CONSUMER PURCHASES FROM ONE BUSINESS TO ANOTHER AND/OR ONE PRODUCT/SERVICE TO ANOTHER”, the entire contents and disclosure of which is hereby incorporated by reference in its entirety. The list of surveys may include a survey name 1302, one or more questions 1304, view rate 1306, response rate 1308, and/or any other relevant data for each survey, including status 1310.

FIG. 14 depicts another user interface 1400 of retailer connect app 120. User interface 1400 may include a pop-up 1402 in which a user can configure a goal for a specific retail site. In another embodiment, a user can configure a goal for a specific retail site via a full-page user interface. In the embodiment illustrated in FIG. 14, a user may set a specific goal for new member enrollment and new transactions for the retail site. In one embodiment, pop-up 1402 further includes a toggle 1404, button, or other mechanism which enables the site-specific goals to be auto-populated with retailer network goals.

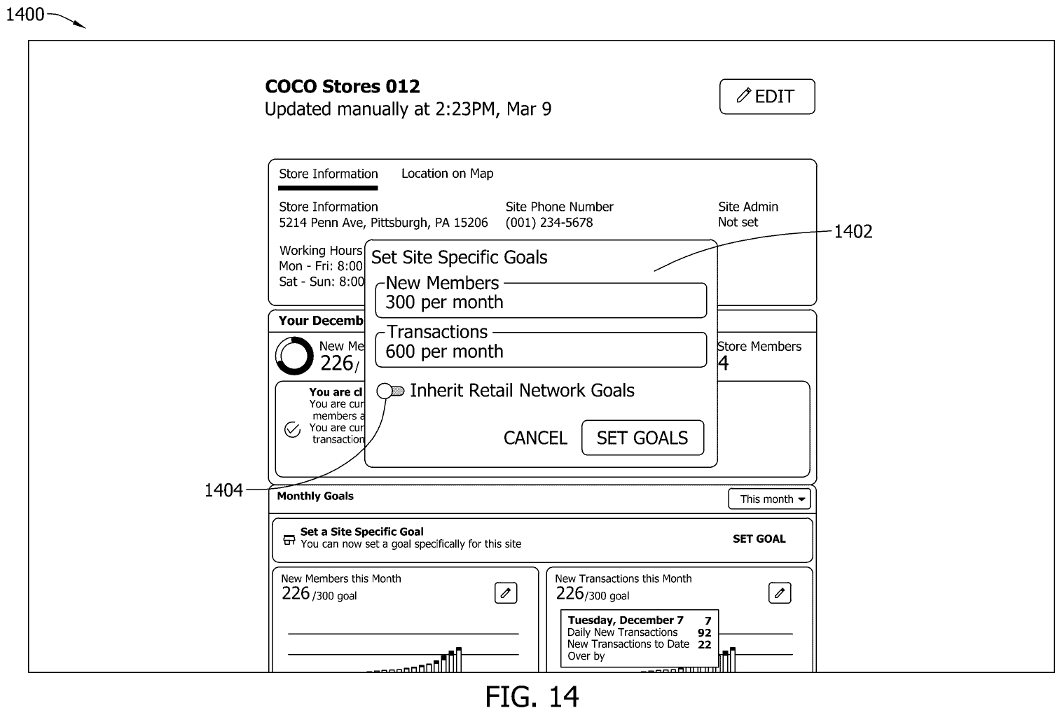

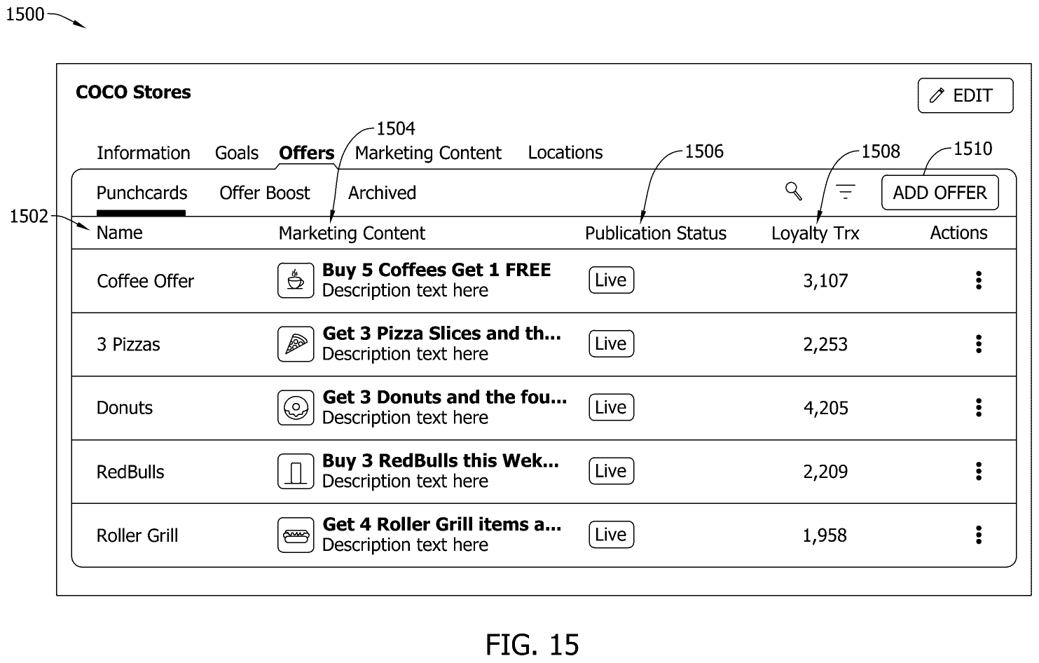

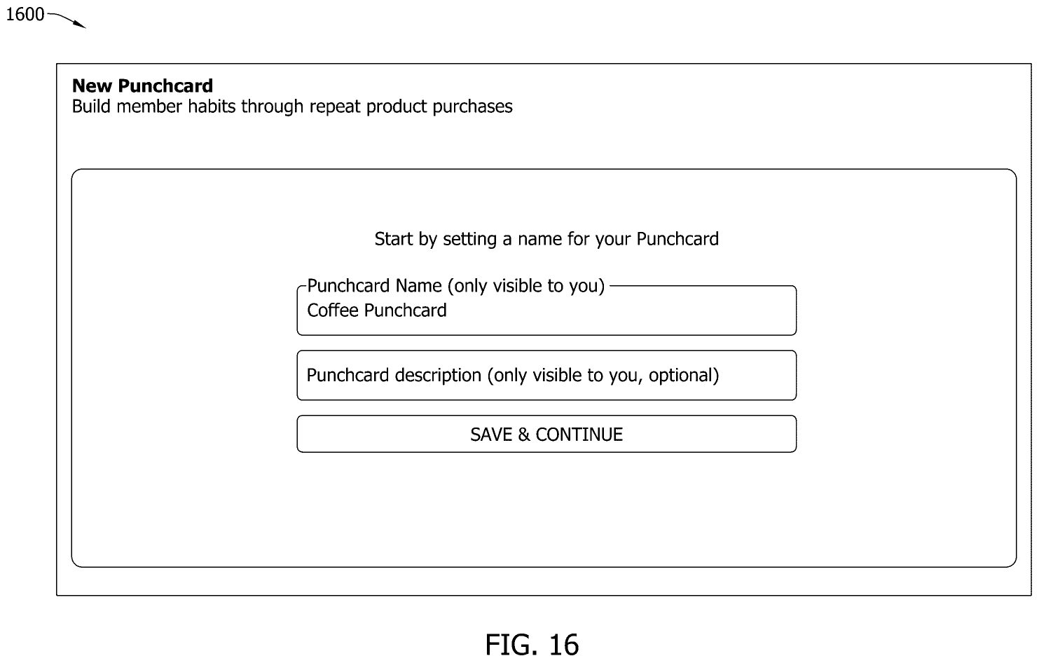

FIG. 15 depicts another user interface 1500 of retailer connect app 120. User interface 1500 may include a list of offers, including, but not limited to, discounts, reward programs, punch cards, and the like, currently being offered by a retailer. For example, in the embodiment illustrated in FIG. 15, a punch card list currently being offered by “COCO Stores” is displayed. The punch card list may include a name 1502, marketing content 1504 (e.g., “Buy 5 coffees get 1 free”), publication status 1506 (e.g., “live”, “not yet live”, “inactive”), loyalty transaction 1508, and/or any other relevant information, for each punch card. In one embodiment, user interface 1500 includes a button 1510 or other mechanism which causes a pop-up to be displayed and/or re-directs the user to another user interface which enables a user can configure a new offer, as discussed in more detail with regards to FIG. 16.

FIG. 16 depicts another user interface 1600 of retailer connect app 120. User interface 1600 may include one or more fillable data elements in which a user can create a new for a new punch card, a punch card description, and/or any other relevant information for the new punch card. In another embodiment, a user can configure a goal for a specific retail site via a full-page user interface.

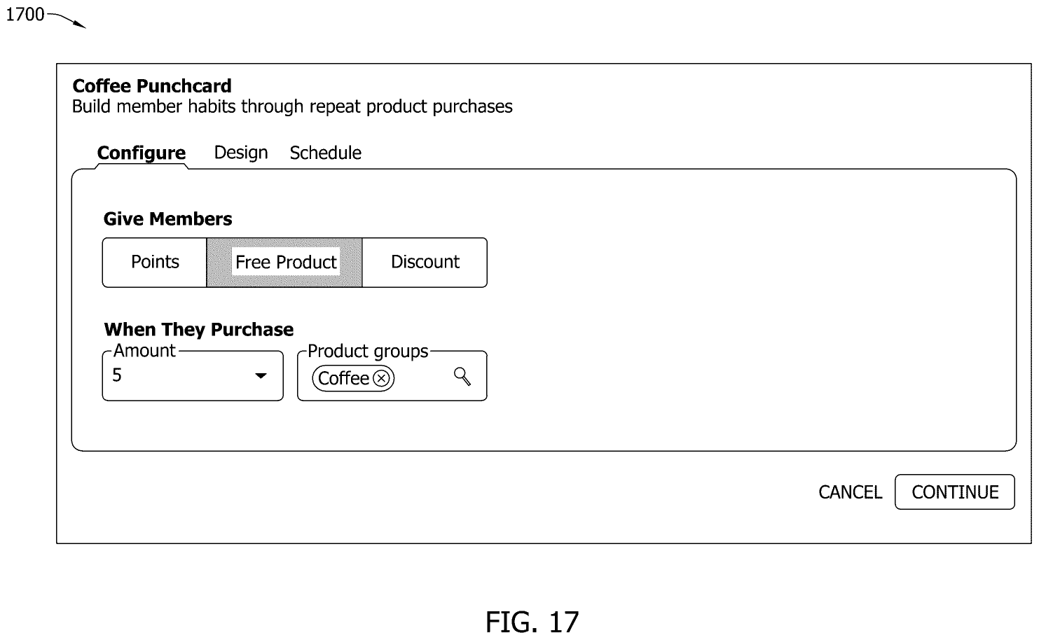

FIG. 17 depicts another user interface 1700 of retailer connect app 120. User interface 1700 may include one or more fillable or selectable data elements and the like in which a user can configure data elements for the new punch card. For example, in the embodiment illustrated in FIG. 17, user interface 1700 can select for the new punch card to give members points, free product, or discount, when a consumer purchase a certain amount of a product or product group (e.g., coffee).

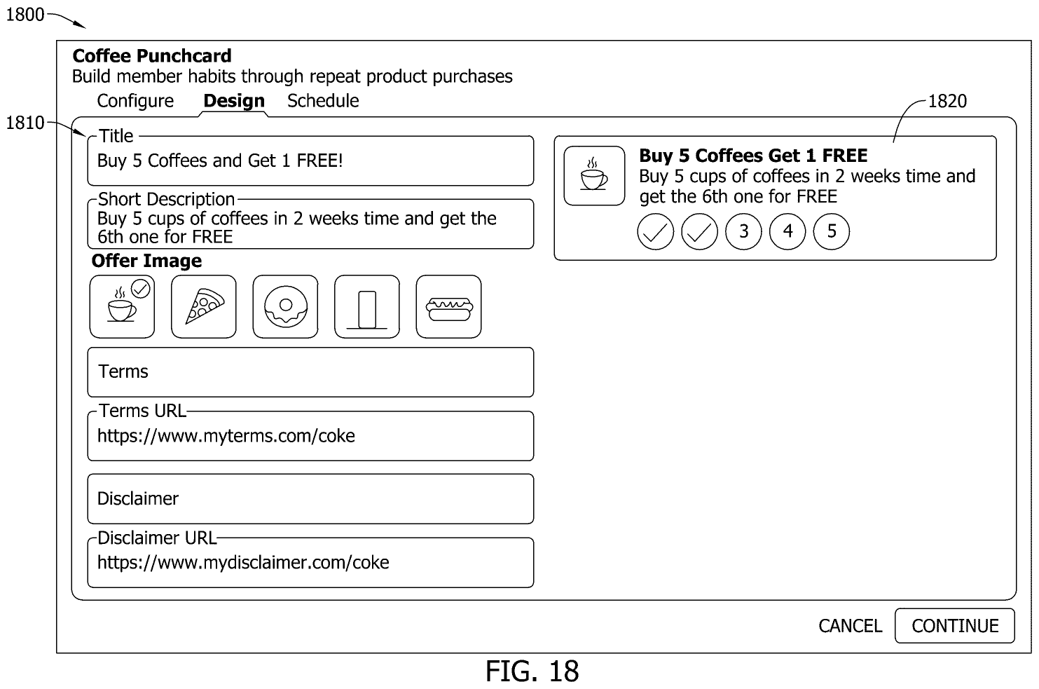

FIG. 18 depicts another user interface 1800 of retailer connect app 120. User interface 1800 may include a selections section 1810 including one or more fillable or selectable data elements in which a user can enter or select data for the new punch card. For example, in the embodiment illustrated in FIG. 17, user interface 1700 can enter a title (e.g., “Buy 5 Coffees and Get 1 FREE!”), description (“Buy 5 cups of coffees in 2 weeks time and get the 6^{th} one for FREE”), terms, terms URL, disclaimer, and/or disclaimer URL for the punch card, and/or select an offer image for the punch card. User interface 1800 may also display a sample punch card 1820 with the elected design choices.

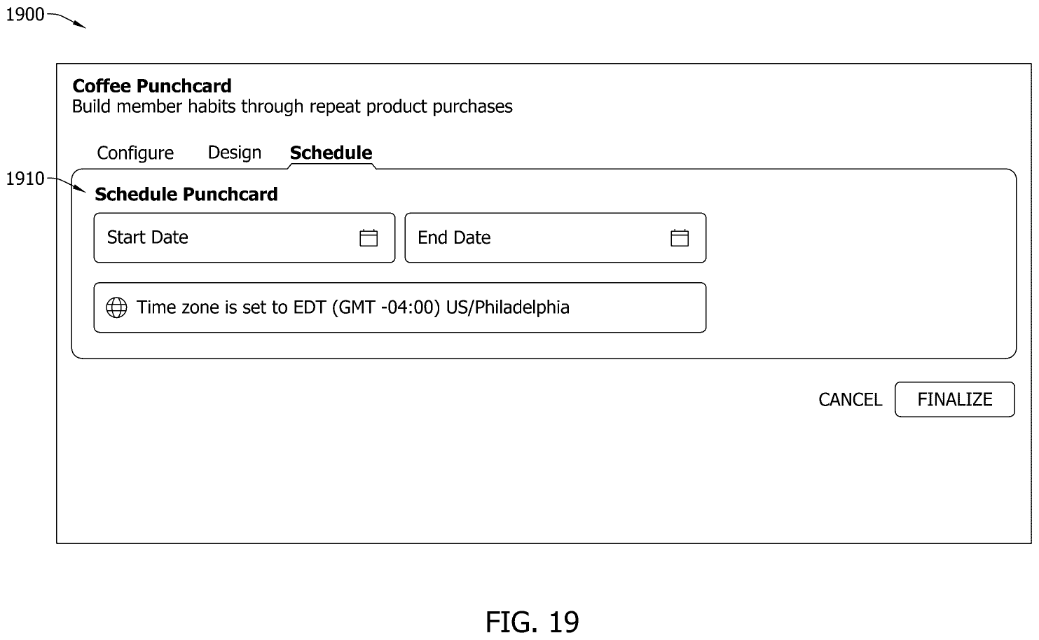

FIG. 19 depicts another user interface 1900 of retailer connect app 120. User interface 1900 may include a selections section 1910 including one or more fillable or selectable data elements in which a user can enter and/or select a time frame for which the punch card, or other offer, is valid. Therefore, a punch card may be valid during a time frame selected by a user.

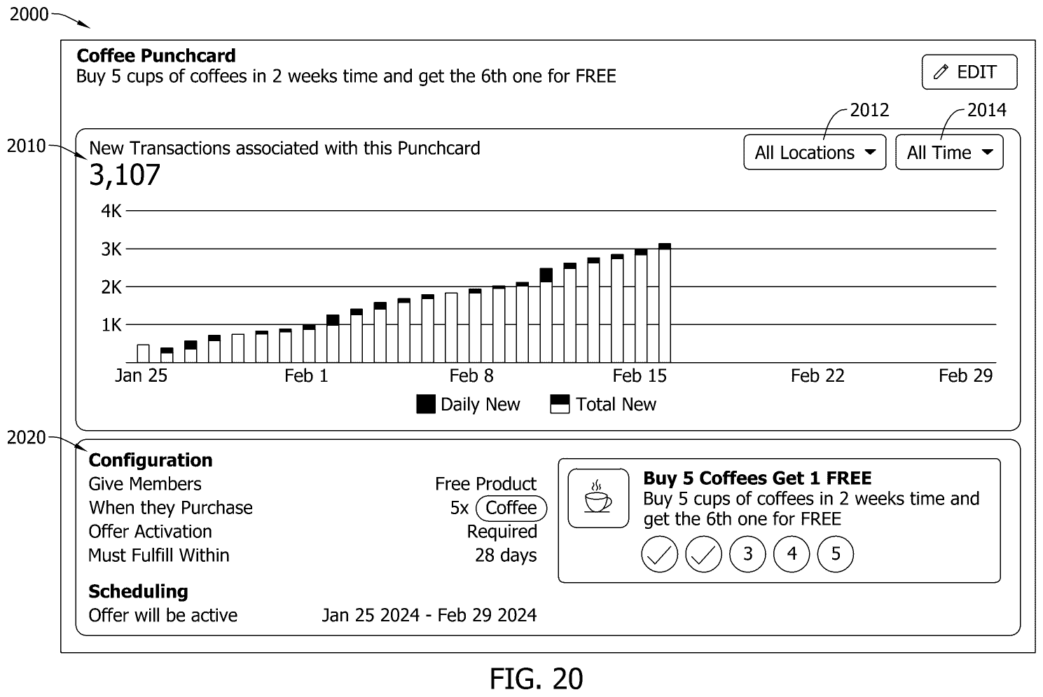

FIG. 20 depicts another user interface 2000 of retailer connect app 120. User interface 2000 may display performance data for a particular offer. For example, in the embodiment illustrated in FIG. 20, user interface 2000 displays a graph 2010 of new transactions associated with the coffee punch card as a function of time. Graph 2010 may show total new transactions and/or daily new transactions. In one embodiment, user interface 2000 may include a drop-down list 2012 or other mechanism enabling a user to generate an offer performance graph for all retail sites, a specific retail site, a group of retail sites, and the like. Additionally, or alternatively, user interface includes a drop-down list 2014 or other mechanism enabling a user to generate an offer performance graph for all time or for a particular time period. In one embodiment, user interface 2000 includes an offer information section 2020 which displays the details of the offer.

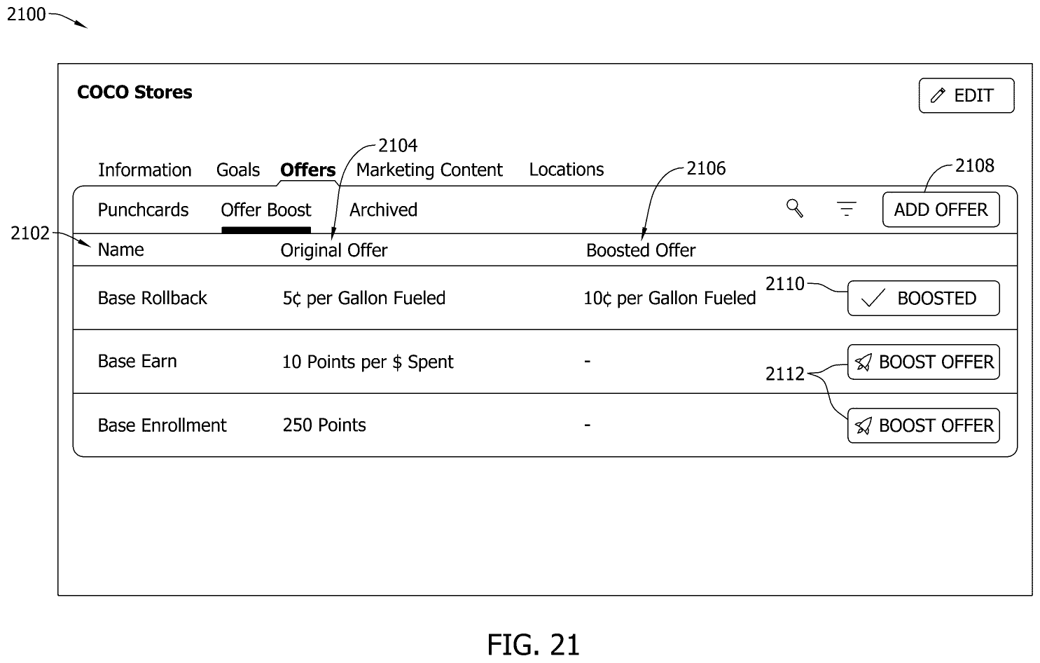

FIG. 21 depicts another user interface 2100 of retailer connect app 120. User interface 2100 may include an offer boost list of offers which may be “boosted” (e.g., increased). The offer boost list may include a name 2104, original offer information 2106 (“5 cents per gallon fueled”), boosted offer information (“10 cents per gallon fueled”), whether the boosted offer is currently active 2110 (e.g., “boosted”), and/or other relevant information for each offer. In one embodiment, user interface 2100 includes, for each offer which has not yet been “boosted” a button 2112 or other mechanism which enables a user to boost the offer. In one embodiment, user interface 2100 includes a button 2108 or other mechanism which causes a pop-up to be displayed and/or re-directs the user to another user interface which enables an offer to be added, as discussed in more detail below.

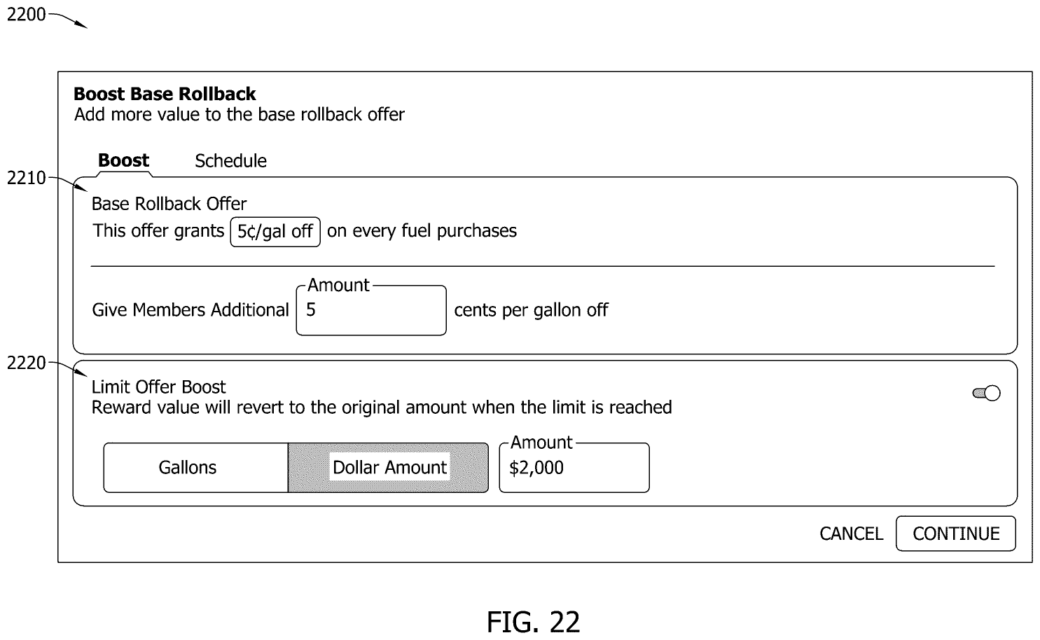

FIG. 22 depicts another user interface 2200 of retailer connect app 120. User interface 2200 may include an offer boost configuration section 2210 and a limit offer boost section 2220. Offer boost configuration section 2210 may include one or more fillable or selectable data elements in which a user can enter or select a boost for a specific offer. For example, in the embodiment illustrated in FIG. 22, “Base Rollback Offer”, offers consumers 5 cents off per galloon on every fuel purchase. Through interface 2210, a user may “boost” this offer with an additional number of cents per galloon off (e.g., an additional 5 cents per galloon off). Limit offer boost section 2220 includes one or more fillable or selectable data elements in which a user can enter or select a reward value limit. In one embodiment, the offer boost may be limited by a unit of the good of service associated with the offer (e.g., gallons) and/or a dollar amount. In one embodiment, when the offer boost limit is reached, the offer will automatically, and in real-time, revert back to the original, or base, offer. Stated another way, when the offer boost limit is reached, the boosted offer will become inactive and the original offer will become active.

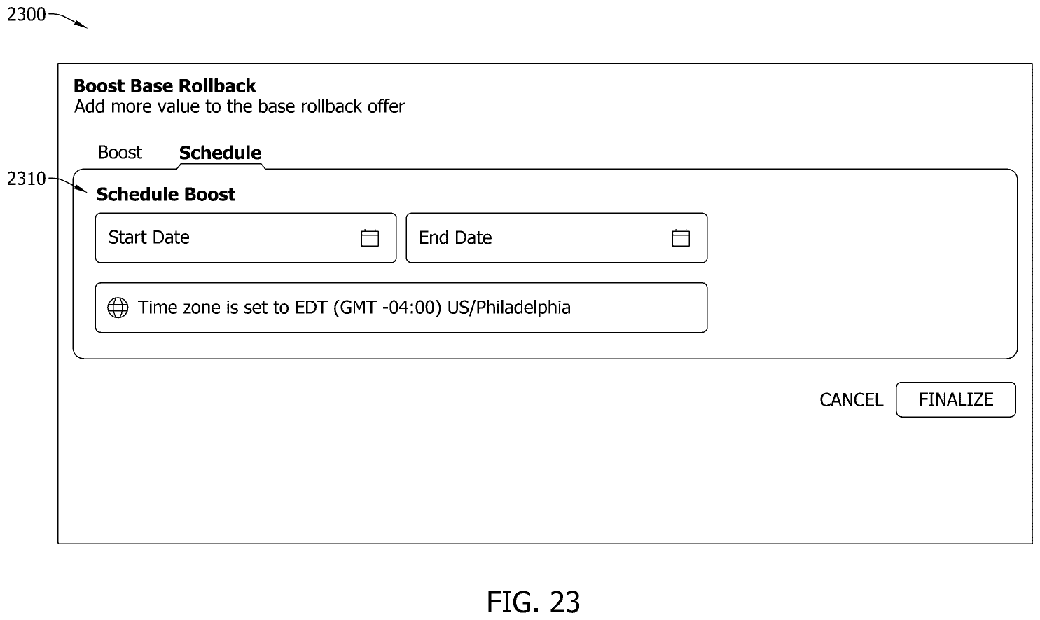

FIG. 23 depicts another user interface 2300 of retailer connect app 120. User interface 2300 may include a selections section 2310 including one or more fillable or selectable data elements in which a user can enter or select a time frame for which the boosted offer can be valid. Therefore, a boosted offer may be valid during a time frame defined by a user.

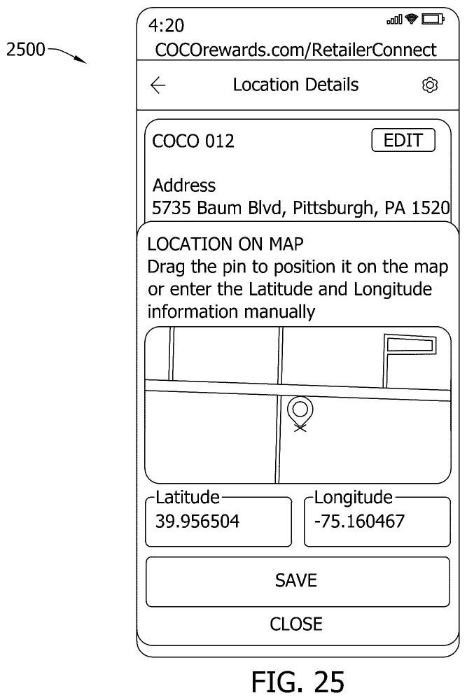

FIG. 24 depicts another user interface 2400 of retailer connect app 120. In one embodiment, a user may be re-directed to user interface 2400 which enables a user input to a link a new retail site to a retailer network. In one embodiment, a new data record associated with the retail site is linked to the retailer network. User interface 2400 may include a store detail section 2410 and a location section 2420. The store detail section may include one or more fillable or selectable data elements for entering or selecting one or more of a location name, an address of the store (street, city, state, zip code), phone number, and/or available services. In one embodiment, store detail section 2410 includes one or more fillable or selectable data elements in which a user can enter or select a retail site's hours of operation (i.e., when the store is open) may be specified. Location section 2420 may include information of a store's location. In one embodiment, the store's location on a map is automatically generated based on the address specified in store detail section 2410 or otherwise obtained (e.g., from a database with retail site addresses, an internet search, etc.). However, in some cases the store's location on the map based on an address associated with the retail site may be inaccurate. For example, if the store is located in a large strip mall, a location pin indicating a store's location may not be at the exact location of the actual storefront. As such, in one embodiment, a user may be able to move a location pin indicating the store's location such that it accurately reflects the location of the store and/or specify the latitude and/or longitude of the exact location of the store in a fillable or selectable data element as discussed in more detail below with regards to FIG. 25.

FIG. 25 depicts another user interface 2500 of retailer connect app 120. In one embodiment, user interface 2500 enables a user to drag a location pin and/or manually enter the latitude and longitude information to establish a retail site's location. In one embodiment, user interface 2500 further includes instructions to user for establishing a retail site's location (e.g., “Drag the pin to position it on the map or enter the latitude and longitude information manually.”). In one embodiment, the updated retail site's location is store in stored in a suitable data store, such as a database (e.g., database 116 shown in FIGS. 1 and 2).

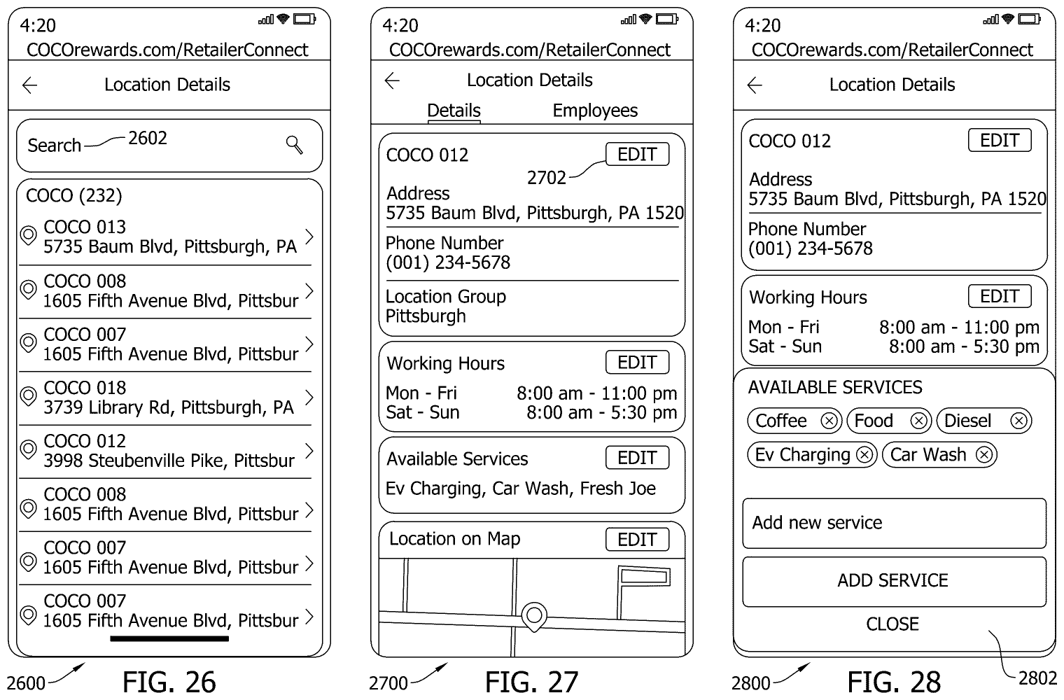

FIG. 26 depicts another user interface 2600 of retailer connect app 120. User interface 2600 may include a list of retail sites associated with a retailer network. In one embodiment, user interface 2600 includes a search bar 2602 configured to accept a user input to be searched against a list of retail sites associated with the retailer network. In one embodiment, a user may select a retail site to be re-directed to a user interface for the selected retail site, such as FIG. 27, described below.

FIG. 27 depicts another user interface 2700 of retailer connect app 120. User interface 2700 may display store information (e.g., store name, phone number, location group), working hours, available services, location on a map, and/or any other relevant information for the retail site. In one embodiment, user interface 2700 includes one or more buttons 2702 or other mechanisms which re-direct a user to a pop-up or another user interface which enables a user to edit or otherwise modify the store information, working hours, available services, location on map, and/or any other relevant information, as discussed in more detail below with respect to FIG. 28.

FIG. 28 depicts another user interface 2800 of retailer connect app 120. User interface 2800 may include a pop-up 2802 which enables a user to modify (e.g., to edit, delete, add) services available at a retail site. A similar pop-up or user interface may be displayed if the user selects a button to modify store information, working hours, locations on map, and/or the like, which enables the user to modify store information, working hours, locations on map, and/or the like.

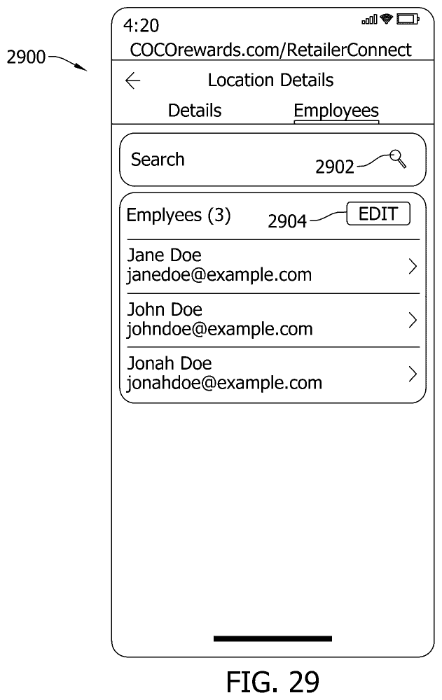

FIG. 29 depicts another user interface 2900 of retailer connect app 120. User interface 2900 may display a list of employees associated with a retail site. In one embodiment, user interface 2900 includes a search bar 2902 configured to accept a user input to be searched against a list of employees associated with a retail site. In one embodiment, user interface 2900 includes a button 2904 or other mechanism which causes a pop-up to be displayed or re-directs a user to another user interface which enables the user to modify the employee list (e.g., add, remove, or edit an employee).

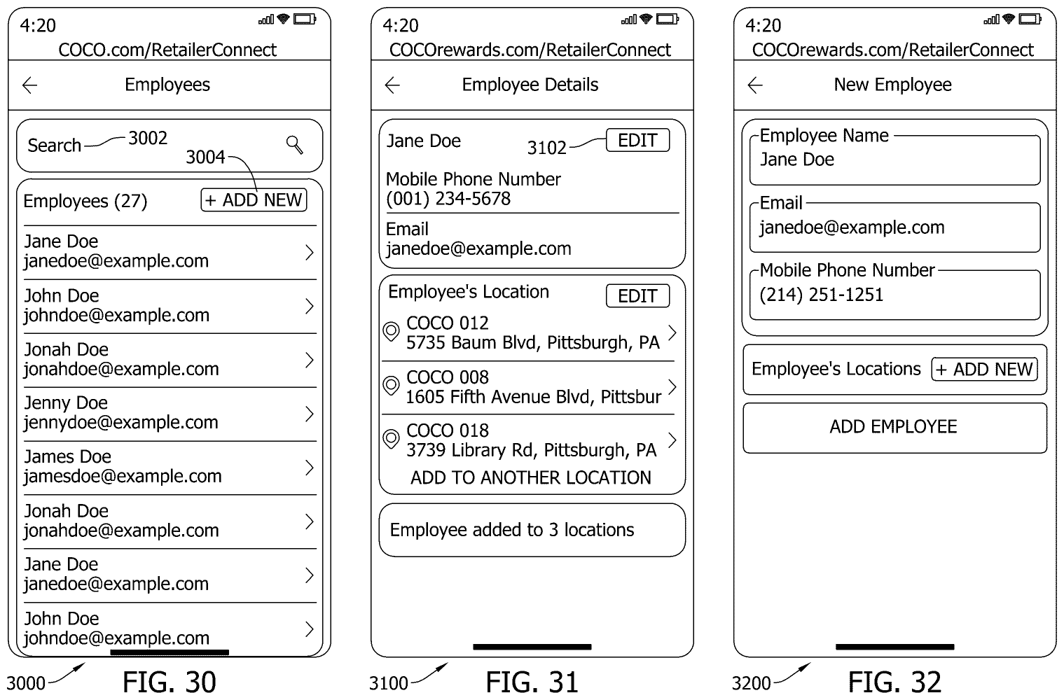

FIG. 30 depicts another user interface 3000 of retailer connect app 120. User interface 3000 may display a list of employees associated with a retailer network. In one embodiment, user interface 3000 includes a search bar 3002 configured to accept a user input to be searched against a list of employees associated with the retailer network. In one embodiment, if a user selects an employee, the user is redirected to a pop-up or another user interface which displays employee details and/or enables the user to modify employee details, as discussed in more detail with regards to FIG. 31. In one embodiment, user interface 3000 includes a button 3004 or other mechanism which re-directs a user to a pop-up or another user interface which enables a user to link an employee to the retailer network, as discussed in more detail with regards to FIG. 32.

FIG. 31 depicts another user interface 3100 of retailer connect app 120. A user may be directed to user interface 3100 when a user selects a specific employee on an employee list. User interface 3100 may display a user's information (e.g., name, mobile phone number, email address) and/or retail sites associated with the employee. User interface 3100 may include a button 3102 or other mechanism which causes a pop up to be displayed or re-directs a user to another user interface enabling the user to modify the employee's information and/or associated retail sites.

FIG. 32 depicts another user interface 3200 of retailer connect app 120. A user may be directed to user interface 3200 when a user selects “add new” employee. User interface 3200 may include one or more fillable or selectable data elements for the employee's personal information, including one or more of the user's name, email, phone number, and/or any other relevant information. In one embodiment, user interface 3200 enables a user to link the employee data record to one or more sites the employee is associated with.

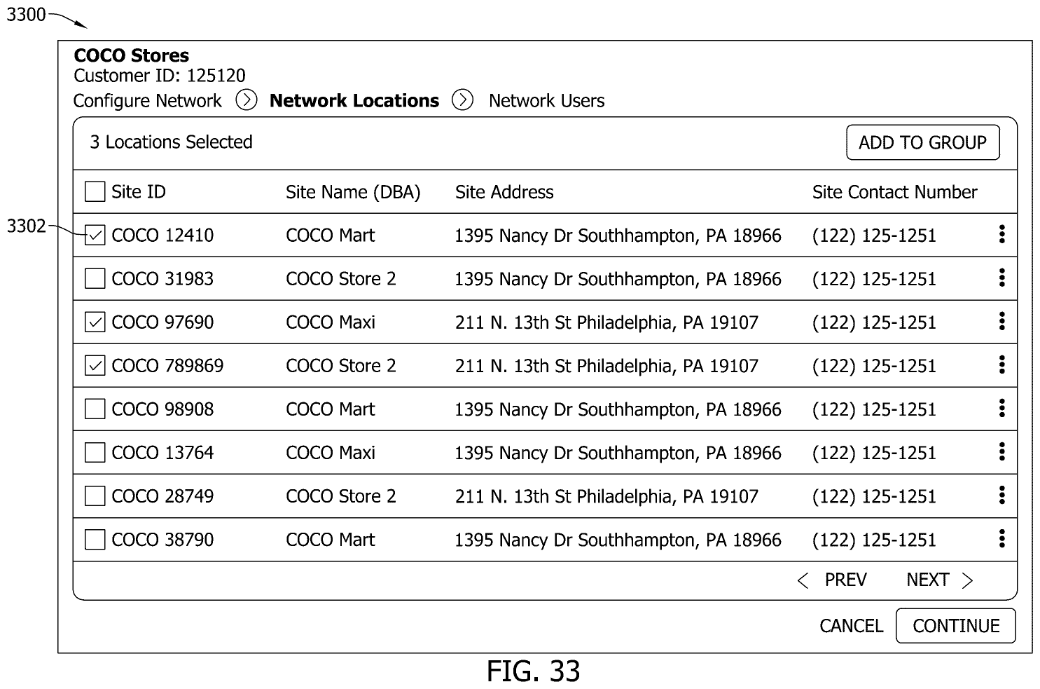

FIG. 33 depicts another user interface 3300 of retailer connect app 120. In one embodiment, a retailer network may comprise one or more networks groups. In a further embodiment, the one or more network groups are configurable by a user. User interface 3300 may list all retail sites belonging to a retailer network. In one embodiment, a group of retail sites may be configurable by a user. For example, user interface 3300 may include a selection mechanism 3302 for each selecting data records associated with the respective retail site the user would like to link to a network group. In one embodiment, data record associated with the retail site is linked to the retailer network.

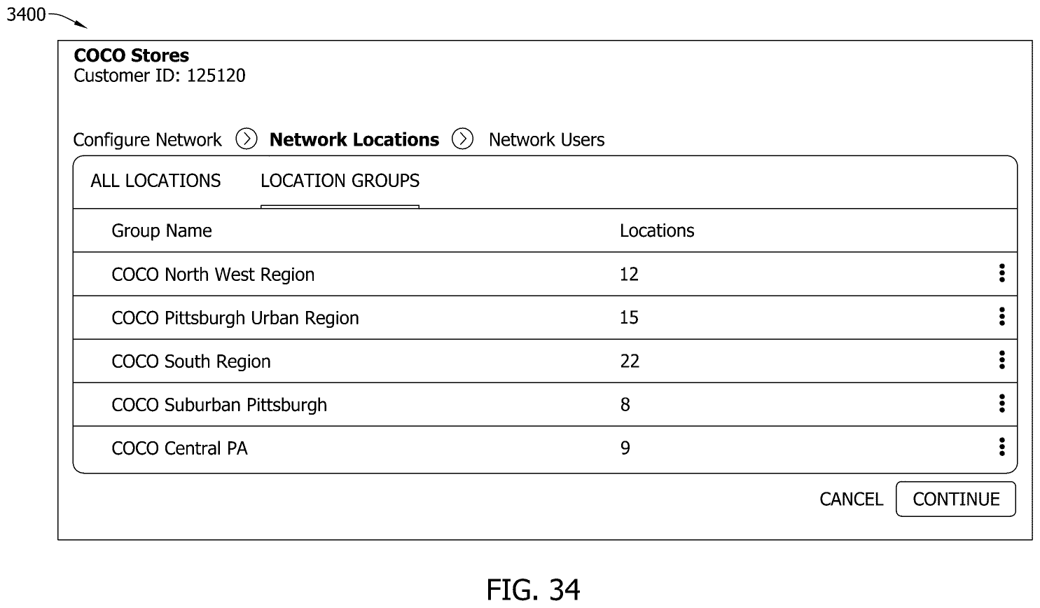

FIG. 34 depicts another user interface 3400 of retailer connect app 120. User interface 3400 lists network locations (e.g., “COCO Stores Northwest Region”, “COCO Stores Pittsburgh Urban Region”, “COCO Stores South Region”, etc.) in a retailer network (e.g., “COCO Stores Stores”). A user may navigate to a drop-down list or other user interface displaying additional information about a particular network group, including, but not limited to, a list of retail sites belonging to that network group. Similarly, a user may navigate to a drop-down list or other user interface may display additional information about each location within a network group, including, but not limited to, the retail site address, operating hours, location on a map, and the like.

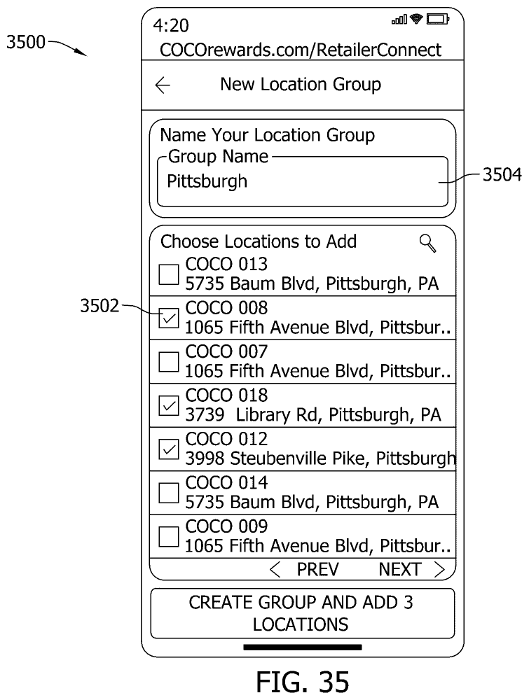

FIG. 35 depicts another user interface 3500 of retailer connect app 120. User interface 3500 may be used to configure a new network group. In one embodiment, retail sites may be grouped into a network group based on their location. For example, in the embodiment illustrated in FIG. 35, all COCO Stores located in Pittsburgh are grouped into a network group. However, the retail sites may be grouped into a network group according to one or more other characteristics (e.g., store size, store profitability, etc.). User interface 3500 may include one or more fillable or selectable data elements 3504, drop-down lists, and the like, enabling a user to enter a name for a new network (e.g., “Pittsburgh”), and any other relevant information. User interface 3500 may list all retail sites in the retailer network, or one or more subgroups of stores in the retailer network (e.g., may be manually or automatically filtered by location, region, etc.). User interface 3500 may further include a selection mechanism 3502 for each retail site which enables a user to add a retail site to a network group. In this way, a user may configure a new network group.

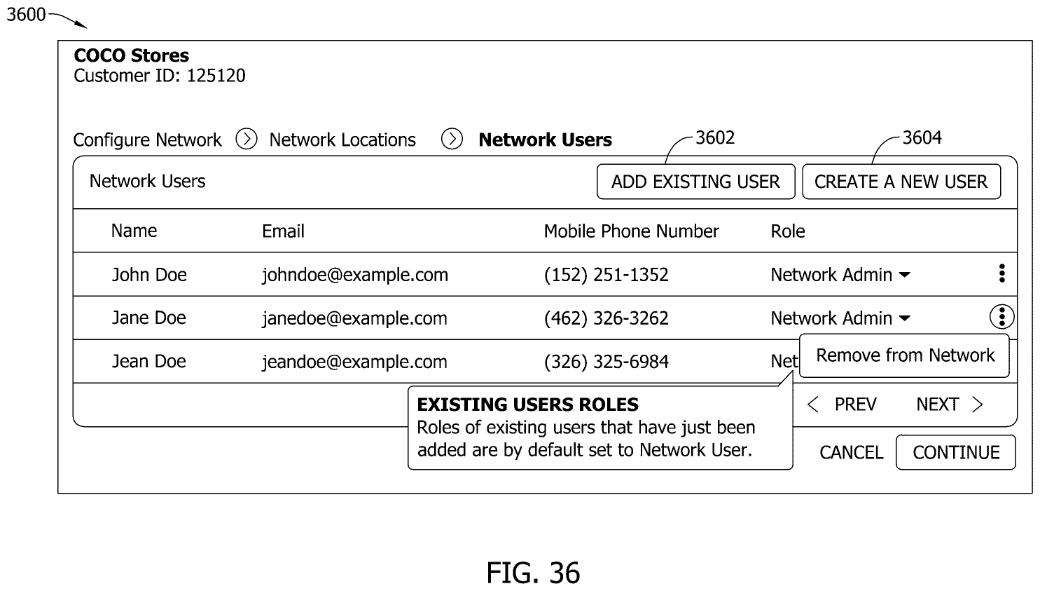

FIG. 36 depicts another user interface 3600 of retailer connect app 120. User interface 3600 lists users associated with a retailer network. The list of users may include user's name, email, phone number, and role (e.g., network admin). User interface 3600 displays one or more buttons 3602, 3604 or other mechanisms which causes a pop-up to be displayed or causes re-direction to another user interface which enables a user to link one or more existing users to a network and/or create a new user and link the new user to the retailer network. When a new user is created, the new user data (e.g., personal information, authentication data, authorization data, etc.) may be stored in one or more databases of the retailer network (e.g., database 116 shown in FIGS. 1 and 2). In one embodiment, the data record associated with the existing or new user is linked to the retailer network.

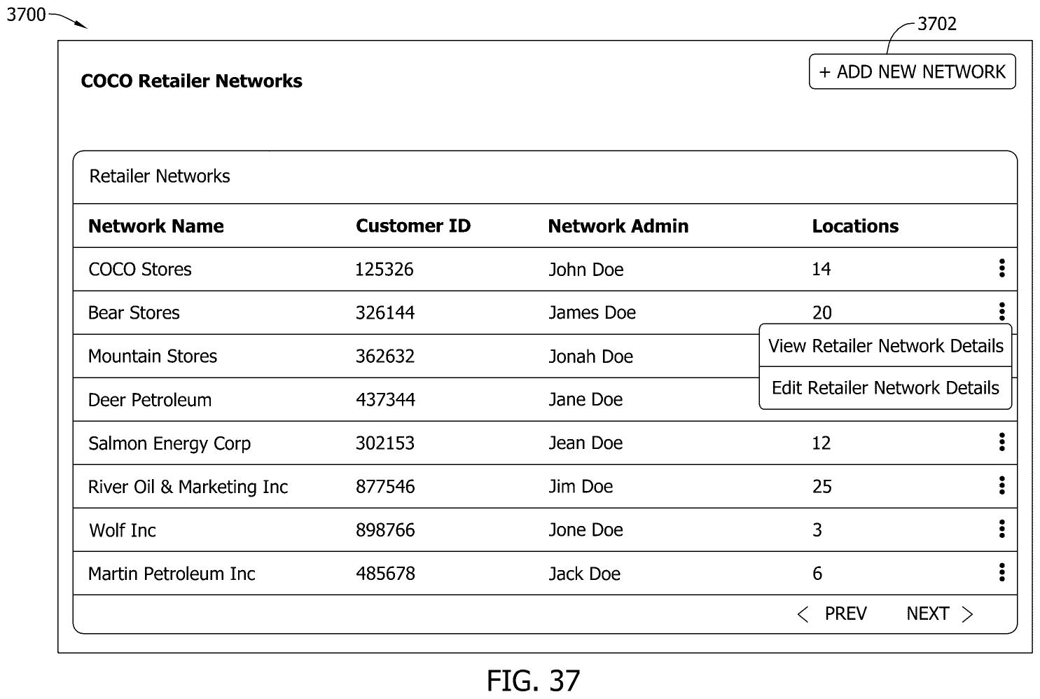

FIG. 37 depicts another user interface 3700 of retailer connect app 120. User interface 3700 lists retailer networks associated with a retailer. The retailer network list may include a name, identifier (e.g., customer ID), network administrator, number of locations, and/or any other relevant information for each retailer network. For example, in the embodiment illustrated in FIG. 37, user interface 3700 lists retailer networks (e.g., “COCO Stores”, “Red Horse Stores”, etc.) associated with a retailer network (e.g., “COCO Retailer”). User interface 3700 may further include a button 3702 or other mechanism which causes a pop-up or re-direction to another user interface which enables a user to create a new network. One or more data records associated with retail sites, employees, etc. may then be linked to the new network.

FIG. 38 is a flow diagram of a process 3800 for collecting and processing performance data in accordance with an embodiment of the present disclosure. The performance data may include transaction data, new member enrollment data, or any other data indicating a performance of a retailer network, a specific retail site, a group of retail sites, an employee, and/or a group of employees. In one embodiment, an identifier, such as a customer ID, is used to link a retail site, a group of retail sites, and/or employees to a retailer network. Similarly, an identifier may be used to link retail sites to a network group and/or employees to one or more specific retail sites. Process 3800 may be executed by one or more processors (e.g., processor 202 illustrated in FIG. 2). At 3802, performance data is received from one or more retail sites. In one embodiment, performance data is received from one retail site. In another embodiment, performance data is received from a plurality of retail sites.

In a further embodiment, performance data is received from a plurality of retail sites associated with a network group. At 3804, the received performance data is normalized. Stated another way, the received performance data is reorganized such that it may be used in queries and analysis. At 3806, the normalized performance data may be transmitted to a data pipeline, which then processes the performance data at 3808. The term “data pipeline”, as used herein, refers to a systematic and automated process for the efficient and reliable movement, transformation, and management of data from one point to another within the computing environment (e.g., retailer connect computing device 110 shown in FIGS. 1 and 2). In one embodiment, the data pipeline comprises a series of data processing steps. If the data is not currently loaded into the data platform, then it is ingested at the beginning of the pipeline. Then there are a series of steps in which each step delivers an output that is the input to the next step. This continues until the pipeline is complete. In some cases, independent steps may be run in parallel.

At 3810, processed performance data is stored in a suitable data store, such as a database (e.g., database 116 shown in FIGS. 1 and 2), data warehouse (e.g., a central repository of information that can be analyzed), and/or cloud storage. Next, at 3812, the processed performance data is enriched. Stated another way, the performance data is enhanced by supplementing missing or incomplete data. The data enrichment may be achieved by using internal data sources (e.g., retailer connect computing device 110 shown in FIGS. 1 and 2) and/or external data sources (e.g., third-party device 112 shown in FIG. 1). The enriched data is then stored 3814 in a suitable data store, such as a database (e.g., database 116 shown in FIGS. 1 and 2), data lake (e.g., a centralized repository that allows you to store all your structured and unstructured data at any scale), data warehouse, and/or cloud storage. In one embodiment, the data enrichment applies one or more analytical tools and/or algorithms to the transformed data to extract meaningful insights, patterns and trends.

The results of this analysis may then be presented in a visual format through dashboards and/or reports. For example, the results of the analysis may be presented as a performance data snapshot of a retailer network (e.g., FIGS. 6 and 7), of a retailer network group, a specific retail site (e.g., FIGS. 10 and 11), of a specific employee e.g., FIG. 9), and/or a group of employees. In one embodiment, data enrichment incorporates artificial intelligence (AI) and machine learning (ML) algorithms for automated decision-making and enhanced predictive analytics. For example, AI/DL may be leveraged to predict whether a store will meet its target performance goals based on historical data, which may be any which shown to have an effect on the transaction data, such as historical weather data, historical time of year data, historical holiday data, and/or historical store size data.

A retailer network, a specific store, a group of stores within a retailer network, etc. may be configurable, as discussed above. A retailer network and aspects of such network may be configurable by one or more user types, each having different permissions. In one embodiment, corporate admins and retailer network admins may create and manage the various user types. In one embodiment, a network admin can read/write management access to all retail sites within the retailer network. In one embodiment, network users can view access to all retail sites within the network. In one embodiment, site admins are limited to read/write management access to one or more retail sites within the network. In one embodiment, site users can view access to one or more retail sites within the retailer network. In one embodiment, corporate admins and retailer network admins can set up and manage network groups (e.g., location groups) within their respective retailer networks. Retail sites can be grouped together by region, store type, etc., for business specific groupings, as discussed in more detail above.

As will be appreciated based upon the foregoing specification, the above-described embodiments of the disclosure may be implemented using computer programming or engineering techniques including computer software, firmware, hardware or any combination or subset thereof. Any such resulting program, having computer-readable code means, may be embodied or provided within one or more computer-readable media, thereby making a computer program product, i.e., an article of manufacture, according to the discussed embodiments of the disclosure. The computer-readable media may be, for example, but is not limited to, a fixed (hard) drive, diskette, optical disk, magnetic tape, semiconductor memory such as read-only memory (ROM), SD card, memory device and/or any transmitting/receiving medium, such as the Internet or other communication network or link. The article of manufacture containing the computer code may be made and/or used by executing the code directly from one medium, by copying the code from one medium to another medium, or by transmitting the code over a network.

These computer programs (also known as programs, software, software applications, “apps”, or code) include machine instructions for a programmable processor, and can be implemented in a high-level procedural and/or object-oriented programming language, and/or in assembly/machine language. As used herein, the terms “machine-readable medium” and “computer-readable medium” refer to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The “machine-readable medium” and “computer-readable medium,” however, do not include transitory signals. The term “machine-readable signal” refers to any signal used to provide machine instructions and/or data to a programmable processor.

As used herein, a processor may include any programmable system including systems using micro-controllers, reduced instruction set circuits (RISC), application specific integrated circuits (ASICs), logic circuits, and any other circuit or processor capable of executing the functions described herein. The above examples are example only, and are thus not intended to limit in any way the definition and/or meaning of the term “processor.”

As used herein, the terms “software” and “firmware” are interchangeable, and include any computer program stored in memory for execution by a processor, including RAM memory, ROM memory, EPROM memory, EEPROM memory, and non-volatile RAM (NVRAM) memory. The above memory types are example only, and are thus not limiting as to the types of memory usable for storage of a computer program.

In one embodiment, a computer program is provided, and the program is embodied on a computer readable medium. In an exemplary embodiment, the system is executed on a single computer system, without requiring a connection to a sever computer. In a further embodiment, the system is being run in a Windows® environment (Windows is a registered trademark of Microsoft Corporation, Redmond, Washington). In yet another embodiment, the system is run on a mainframe environment and a UNIX® server environment (UNIX is a registered trademark of X/Open Company Limited located in Reading, Berkshire, United Kingdom). The application is flexible and designed to run in various different environments without compromising any major functionality.

In some embodiments, the system includes multiple components distributed among a plurality of computing devices. One or more components may be in the form of computer-executable instructions embodied in a computer-readable medium. The systems and processes are not limited to the specific embodiments described herein. In addition, components of each system and each process can be practiced independent and separate from other components and processes described herein. Each component and process can also be used in combination with other assembly packages and processes. The present embodiments may enhance the functionality and functioning of computers and/or computer systems.

As used herein, an element or step recited in the singular and preceded by the word “a” or “an” should be understood as not excluding plural elements or steps, unless such exclusion is explicitly recited. Furthermore, references to “example embodiment” or “one embodiment” of the present disclosure are not intended to be interpreted as excluding the existence of additional embodiments that also incorporate the recited features.

The patent claims at the end of this document are not intended to be construed under 35 U.S.C. § 112 (f) unless traditional means-plus-function language is expressly recited, such as “means for” or “step for” language being expressly recited in the claim(s).

This written description uses examples to disclose the disclosure, including the best mode, and also to enable any person skilled in the art to practice the disclosure, including making and using any devices or systems and performing any incorporated methods. The patentable scope of the disclosure is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A computing system for creating and managing a retailer network, the computing system comprising at least one processor and a memory device, the at least one processor programmed to perform steps including:
receiving an identifier for a retailer network;
linking at least one retailer to the identifier;
in response to the linking the identifier to the at least one retailer, automatically receiving, from at least one remote computing device, performance data for the at least one retailer, the performance data including at least one of new member enrollment data or transaction data; and
normalizing and processing the performance data, wherein normalizing and processing the performance data identifies one or more patterns, trends, or predictions related to sales by the retailer.

2. The computing system of claim 1, wherein the at least one processor is further programmed to cause to be displayed, on a user interface of a user computing device, a visual representation of the processed performance data.

3. The computing system of claim 1, wherein the at least on retailer comprises a plurality of retailers.

4. The computing system of claim 3, wherein the at least one processor is further programmed to rank the plurality of retailers based on the processed performance data and causing to be displayed to the retailer a ranking of the plurality of retailers.

5. The computing system of claim 1, wherein linking the at least one retailer to the identifier occurs in response to a user input.

6. The computing system of claim 1, wherein the at least one processor is further programmed to receive, in real-time from the at least one remote computing device, updated performance data, normalize and process the performance data.

7. The computing system of claim 1, wherein the at least one processor is further programmed to receive performance goal data and compare the processed performance data to the performance goal data.

8. A computer-implemented method for creating and managing a retailer network, the method comprising:
receiving an identifier for a retailer network;
linking at least one retailer to the identifier;
in response to the linking the identifier to the at least one retailer, automatically receiving, from at least one remote computing device, performance data for the at least one retailer, the performance data including at least one of new member enrollment data or transaction data;
normalizing and processing the performance data; and
causing to be displayed, on a user interface of a user computing device, a visual representation of the processed performance data.

9. The computer-implemented method of claim 8, wherein the at least on retailer comprises a plurality of retailers.

10. The computer-implemented method of claim 9, further comprising ranking the plurality of retailers based on the processed performance data and causing to be displayed, on the user interface of the user computing device, the ranking of the plurality of retailers.

11. The computer-implemented method of claim 8, wherein linking the at least one retailer to the identifier occurs in response to a user input.

12. The computer-implemented method of claim 8, further comprising receiving, in real-time from the at least one remote computing device, updated performance data, normalizing and processing the performance data, and causing to be displayed, on the user interface of the user computing device, a visual representation of the updated processed performance data.

13. The computer-implemented method of claim 8, wherein normalizing and processing the performance data comprises applying one or more algorithms to the performance data to identify one or more patterns, trends, or predictions.

14. The computer-implemented method of claim 8, further comprising receiving performance goal data and comparing the processed performance data to the performance goal data.

15. At least one non-transitory computer-readable medium comprising instructions stored thereon for creating and managing a retailer network, the instructions executable by at least one processor to cause the at least one processor to perform steps including:
receiving an identifier for a retailer network;
linking at least one retailer to the identifier;
in response to the linking the identifier to the at least one retailer, automatically receiving, from at least one remote computing device, performance data for the at least one retailer, the performance data including at least one of new member enrollment data or transaction data;
normalizing and processing the performance data; and
causing to be displayed, on a user interface of a user computing device, a visual representation of the processed performance data.

16. The at least one non-transitory computer-readable medium according to claim 15, wherein the at least on retailer comprises a plurality of retailers.

17. The at least one non-transitory computer-readable medium according to claim 16, wherein the instructions further cause that at least one processor to rank the plurality of retailers based on the processed performance data and cause to be displayed, on the user interface of the user computing device, the ranking of the plurality of retailers.

18. The at least one non-transitory computer-readable medium according to claim 15, wherein linking the at least one retailer to the identifier occurs in response to a user input.

19. The at least one non-transitory computer-readable medium according to claim 15, wherein the instructions further cause that at least one processor to receive, in real-time from the at least one remote computing device, updated performance data, normalize and process the performance data, and cause to be displayed, on the user interface of the user computing device, a visual representation of the updated processed performance data.

20. The at least one non-transitory computer-readable medium according to claim 15, wherein normalizing and processing the performance data comprises applying one or more algorithms to the performance data to identify one or more patterns, trends, or predictions.
